(19) United States
(12) Patent Application Publication
(10) Pub. No.: US 2026/0300747 A1
(43) Pub. Date: Oct. 1, 2026

(54) SYSTEMS AND METHODS FOR CORRELATING AND OPTIMIZING MULTIMODAL DATA USING ARTIFICIAL INTELLIGENCE MODELS

(71) Applicant: ACCENTURE GLOBAL SOLUTIONS LIMITED, Dublin 4 (IE)

(72) Inventors: Karthik Rajkumar KANNAN, Chennai (IN); Joshy RAVINDRAN, Bangalore (IN); Bipin Chandra PRABHA, Bangalore (IN); Ankit Singh BHADAURIA, Noida (IN)

(73) Assignee: ACCENTURE GLOBAL SOLUTIONS LIMITED, Dublin 4 (IE)

(21) Appl. No.: 19/089,819

(22) Filed: Mar. 25, 2025

(51) Int. Cl. G06N 3/092; G06N 3/0455; G06N 3/0495

(52) U.S. Cl. CPC G06N 3/092; G06N 3/0455; G06N 3/0495

(57) ABSTRACT

Systems and methods for generating recommendations by correlating and optimizing multi-modal datasets using Artificial Intelligence (AI) models are disclosed. A system receives and encodes the multi-modal datasets into latent vectors using a Vector Quantized Variational Autoencoders (VQVAE) model. Based on the encoded latent vectors, the system trains a transformer model and uses the trained transformer model to generate feature vectors that represent correlations between the multi-modal datasets. Based on the generated feature vectors, the system generates decision-making strategies for each of the multi-modal datasets. The system modifies domain policies associated with the enterprise by processing the decision-making strategies and real-time feedback using Reinforcement Learning (RL) agent and determines contextual predictions by processing historical data using Long Short-Term Memory (LSTM) model. By integrating the modified domain policies with the contextual predictions, the system generates the recommendations and outputs the recommendations on a user device for performing actions on real-world enterprise environment.

### TECHNICAL FIELD

Various embodiments described herein relate generally to system, method, and non-transitory computer readable medium for correlating and optimizing multimodal datasets using Artificial Intelligence (AI) models.

### BACKGROUND

With an exponential increase in use and growth of cloud computing, multiple cloud service providers exist for providing computing resources to enterprises for data processing, data storage, application hosting, and/or the like. The cloud service providers may provide the computing resources to the enterprises based on an agreement between the cloud service providers and the respective enterprises. The agreement may specify an average cost/budget for utilization of the computing resources, a threshold associated with utilization of the computing resources, a specified rate at which the enterprises are permitted to utilize the computing resources, and/or the like. Therefore, the enterprises perform cloud management actions for optimizing utilization of the computing resources.

An enterprise utilizes conventional cloud management tools for performing the cloud management actions. The conventional cloud management tools generate decision-making strategies and use the decision-making strategies for performing the cloud management actions. The decision-making strategies may be generated by collecting, integrating/aggregating, and analyzing data generated from different domains of the enterprise such as financial operations, security operations, agility operations, technical operations (Information Technology (IT) operations), and/or the like. However, the data generated from the different domains may be associated with different modalities and may include complex data with enriched insights. Increased amount of such a data may pose limitations for the conventional cloud management tools in terms of integration and analysis of the data. Due to the limitations, the conventional cloud management tools may fail to capture complex relationships and dependencies between the data associated with the different modalities as well as fail to capture deeper and contextual insights and to provide agility and precision required for generating the decision-making strategies. In addition, the conventional cloud management tools may lack capabilities to dynamically adapt to changing conditions and complexities in the cloud environment and in functions of the enterprises for generating the decision-making strategies. Therefore, the decision-making strategies generated by the conventional cloud management tools may be inefficient, inaccurate, and inflexible. Further, generation of the decision-making strategies may be expensive and time consuming.

Utilization of the inefficient, inaccurate, and inflexible decision-making strategies may further result in anomalous utilization of the computing resources (e.g., misallocation of the computing resources, overutilization of the computing resources, inefficient allocation of the computing resources, an unexpected combination of the computing resources, and/or the like). The anomalous utilization of the computing resources may further disrupt/hinder the functions of the enterprises. Therefore, a significant amount of time and expense may expend for performing the cloud management actions using the conventional cloud management tools.

### SUMMARY

In an aspect, the present disclosure relates to a system including a processor, and a memory communicably coupled to the processor, wherein the memory includes processor-executable instructions, which, when executed by the processor, cause the processor to receive a plurality of multi-modal datasets from a plurality of data sources, wherein the plurality of multi-modal datasets includes datasets from a plurality of domains corresponding to a plurality of functions within an enterprise, encode the received plurality of multi-modal datasets into a plurality of latent vectors using a Vector Quantized Variational Autoencoders (VQVAE) model, wherein the plurality of latent vectors represents essential features of the received plurality of multi-modal datasets, train a transformer model based on the encoded plurality of latent vectors, generate a plurality of feature vectors using the trained transformer model, wherein the plurality of feature vectors represents a plurality of correlations between the plurality of multi-modal datasets, generate at least one decision-making strategy for each of the multi-modal datasets based on the generated plurality of feature vectors using the transformer model, modify at least one domain policy associated with the enterprise based on the generated at least one decision-making strategy and real-time feedback using an Artificial Intelligence (AI) model, generate a plurality of recommendations for performing at least one action corresponding to the plurality of multi-modal datasets based on the modified at least one domain policy, and historical data, and output the generated plurality of recommendations for performing the at least one action on a user interface of a user device.

In another aspect, the present disclosure relates to a method including receiving, by a processor, a plurality of multi-modal datasets from a plurality of data sources, wherein the plurality of multi-modal datasets comprises datasets from a plurality of domains corresponding to a plurality of functions within an enterprise. The method includes encoding, by the processor, the received plurality of multi-modal datasets into a plurality of latent vectors using a Vector Quantized Variational Autoencoders (VQVAE) model, wherein the plurality of latent vectors represents essential features of the received plurality of multi-modal datasets. The method includes training, by the processor, a transformer model based on the encoded plurality of latent vectors. The method includes generating, by the processor, a plurality of feature vectors using the trained transformer model, wherein the plurality of feature vectors represents a plurality of correlations between the plurality of multi-modal datasets. The method includes generating, by the processor, at least one decision-making strategy for each of the plurality of multi-modal datasets based on the generated plurality of feature vectors using the transformer model. The method includes modifying, by the processor, at least one domain policy associated with the enterprise based on the generated at least one decision-making strategy and real-time feedback using an Artificial Intelligence (AI) model. The method includes generating, by the processor, a plurality of recommendations for performing at least one action corresponding to the plurality of multi-modal datasets based on the modified at least one domain policy, and historical data. The method includes outputting, by the processor, the generated plurality of recommendations for performing the at least one action on a user interface of a user device.

In another aspect, the present disclosure relates to a non-transitory computer-readable medium including machine-executable instructions that may be executable by a processor to perform the method as discussed herein.

It is appreciated that method in accordance with the present disclosure can include any combination of the aspects and features described herein. That is, the method in accordance with the present disclosure are not limited to the combinations of aspects and features specifically described herein, but also include any combination of the aspects and features provided.

The details of one or more implementations of the present disclosure are set forth in the accompanying drawings and the description below. Other features of the present disclosure will be apparent from the description and drawings, and from the claims.

### BRIEF DESCRIPTION OF THE FIGURES

Various implementations in accordance with the present disclosure will be described with reference to the drawings, in which:

FIG. 1 depicts an exemplary environment used to execute implementations of the present disclosure.

FIG. 2 depicts an exemplary conceptual architecture of a recommendation manager of a system to generate recommendations for performing one or more actions, in accordance with implementations of the present disclosure.

FIG. 3 is an exemplary flow diagram presenting a method for encoding multi-modal datasets 250 into latent vectors, in accordance with implementations of the present disclosure.

FIG. 4A depicts exemplary multi-modal datasets, in accordance with implementations of the present disclosure.

FIG. 4B depicts exemplary encoded latent vectors of the multi-modal datasets, in accordance with implementations of the present disclosure.

FIG. 5 is an exemplary flow diagram presenting a method for determining correlations between the multi-modal datasets using the respective latent vectors, in accordance with implementations of the present disclosure.

FIG. 6 depicts an exemplary illustration of using a trained transformer model to determine the correlations between the multi-modal datasets, in accordance with implementations of the present disclosure.

FIG. 7 is an exemplary flow diagram presenting a method for computing an impact matrix for the multi-modal datasets, in accordance with implementations of the present disclosure.

FIG. 8 depicts an exemplary impact matrix, in accordance with implementations of the present disclosure.

FIG. 9 is an exemplary flow diagram presenting a method for generating one or more decision-making strategies for each of the multi-modal datasets using the impact matrix, in accordance with implementations of the present disclosure.

FIG. 10 is an exemplary flow diagram presenting a method for generating modified one or more domain policies for the multi-modal datasets, in accordance with implementations of the present disclosure.

FIG. 11A depicts exemplary one or more decision-making strategies determined for each of the multi-modal datasets, in accordance with implementations of the present disclosure.

FIG. 11B depicts exemplary metrics representing a current state of a real-world enterprise environment, in accordance with implementations of the present disclosure.

FIG. 11C depicts an exemplary illustration including an exemplary domain policy modified based on an action and a reward function, in accordance with implementations of the present disclosure.

FIG. 12 is an exemplary flow diagram that presents a method for generating recommendations for performing one or more actions, in accordance with implementations of the present disclosure.

FIG. 13A depicts exemplary historical data, in accordance with implementations of the present disclosure.

FIG. 13B depicts exemplary contextual predictions, in accordance with implementations of the present disclosure.

FIG. 13C depicts an exemplary modified domain policy, in accordance with implementations of the present disclosure.

FIGS. 13D and 13E depict exemplary recommendations generated for performing the one or more actions, in accordance with implementations of the present disclosure.

FIG. 14 is flow diagram that presents a method for generating the recommendations for performing the one or more actions corresponding to the multi-modal datasets, in accordance with implementations of the present disclosure.

FIG. 15 depicts an example computer system, in accordance with implementations of the present disclosure.

Like reference numbers and designations in the various drawings indicate like elements.

### DETAILED DESCRIPTION

In the following description, various embodiments will be illustrated by way of example and not by way of limitation in the figures of the accompanying drawings. References to various embodiments in this disclosure are not necessarily to the same embodiment, and such references mean at least one. While specific implementations and other details are discussed, it is to be understood that this is done for illustrative purposes only. A person skilled in the relevant art will recognize that other components and configurations may be used without departing from the scope of the claimed subject matter.

Reference to any “example” herein (e.g., “for example,” “an example of” by way of example” or the like) are to be considered non-limiting examples regardless of whether expressly stated or not.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any exemplified term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

The term “comprising” when utilized means “including, but not necessarily limited to;” it specifically indicates open-ended inclusion or membership in the so-described combination, group, series, and the like.

The term “a” means “one or more” unless the context clearly indicates a single element.

“First,” “second,” and/or the like, are labels to distinguish components or blocks of otherwise similar names but does not imply any sequence or numerical limitation.

“And/or” for two possibilities means either or both of the stated possibilities (“A and/or B” covers A alone, B alone, or both A and B take together), and when present with three or more stated possibilities means any individual possibility alone, all possibilities taken together, or some combination of possibilities that is less than all of the possibilities. The language in the format “at least one of A . . . and N” where A through N are possibilities means “and/or” for the stated possibilities (e.g., at least one A, at least one N, at least one A and at least one N, and/or the like).

It should also be noted that in some alternative implementations, the functions/acts noted may occur out of the order noted in the figures. For example, two steps disclosed or shown in succession may in fact be executed substantially concurrently or may sometimes be executed in the reverse order, depending upon the functionality/acts involved.

Specific details are provided in the following description to provide a thorough understanding of embodiments. However, it will be understood by one of ordinary skill in the art that embodiments may be practiced without these specific details. For example, systems may be shown in block diagrams so as not to obscure the embodiments in unnecessary detail. In other instances, well-known processes, structures, and techniques may be shown without unnecessary detail in order to avoid obscuring example embodiments.

The specification and drawings are to be regarded in an illustrative rather than a restrictive sense. It will, however, be evident that various modifications and changes may be made thereunto without departing from the broader scope of the disclosure as set forth in the claims.

This disclosure should be interpreted according to the exemplary definitions provided below. In case of a contradiction between the definitions in the definitions section and other sections of this disclosure, this section should prevail. In case of a contradiction between the definitions in this section and a definition or a description in any other document, including in another document incorporated in this disclosure by reference, this section should prevail, even if the definition or the description in the other document is commonly accepted by a person of ordinary skill in the art.

“Computing resources” and/or the like, may refer to resources provided by cloud service providers to enterprises for data processing, data storage, application hosting, and/or the like. In some examples, the computing resources may include network resources, data storage, servers, applications, services, and/or the like.

“Computational resources” and/or the like, may refer to resources of a system that is configured for generating recommendations to perform actions/cloud management actions. In some examples, the computational resources may include processing resources, memory resources, communication resources, and/or the like.

“Actions”, “Cloud management actions”, and/or the like, may refer to actions that include optimizing utilization of the computing resources, while managing budget, and maintaining security, reliability, and operational efficiency of the computing resources.

“Multi-modal datasets” and/or the like, may refer to datasets associated with multiple modalities. For example, the multi-modal datasets may include application files, data arrays, multimedia files, image (or video) files, text files, data objects, and/or the like.

“Set of decision-making strategies” and/or the like, may refer to strategies predefined for the multi-modal datasets. Each decision-making strategy in the set of decision-making strategies may include the actions and/or recommendations for performing the actions.

“Decision-making strategies” and/or the like, may refer to strategies determined from the set of decision-making strategies. The decision-making strategies may indicate optimal actions and/or optimal recommendations for performing the actions.

“Domain policies” and/or the like, may refer to policies associated with an enterprise that indicate the actions for enabling adjustments to budget allocations, security measures, project timelines, and/or the like.

“Recommendations” and/or the like, may refer to insights or suggestions provided for performing the actions.

Implementations of the present disclosure provide a comprehensive and efficient multi-modal correlation framework for generating recommendations to perform one or more actions.

The one or more actions may correspond to one or more cloud management actions that include optimizing utilization and allocation of computing resources, enhancing security measures, and improving operational efficiency.

The recommendations for performing the one or more actions may be generated by correlating and optimizing multi-modal datasets captured from different domains of an enterprise using various models such as a Vector Quantized Variational Autoencoders (VQVAE) model, a transformer model, an Artificial Intelligence (AI) model, a Reinforcement Learning (RL) agent, an Long Short-Term Memory (LSTM) model, and/or the like. The VQVAE model may be utilized for encoding and transforming the multi-modal datasets including high-dimensional data into low-dimensional latent vectors. Therefore, essential features from the multi-modal datasets may be captured while significantly reducing its dimensionality and facilitating more efficient analysis of the multi-modal datasets. The transformer model may be used to determine correlations between the multi-modal datasets based on the respective low-dimensional latent vectors. The correlations may capture intricate patterns between the multi-modal datasets, which may be determined by capturing complex dependencies and relationships between the multi-model datasets. Further, the correlations between the multi-modal datasets determined using the transformer model may be used to generate one or more decision-making strategies for each of the multi-modal datasets. The AI model and the RL agent may be used to modify one or more domain policies associated with the enterprise based on the generated one or more decision-making strategies and real-time feedback. The one or more domain policies modified using the AI model and the RL agent may be adapted to the one or more decision-making strategies in real-time, ensuring improved performance and efficiency in generating the recommendations. The LSTM model may be used to generate the recommendations for performing the one or more actions with respect to the multi-modal datasets by integrating the modified one or more domain policies with historical data. By integrating the modified one or more domain policies with the historical data, relevance of insights, long-term dependencies, and trends may be captured for generating the contextually enriched predictions and recommendations. The recommendations may allow users to make informed and strategic decisions with confidence for performing the one or more actions.

Therefore, the proposed multi-modal correlation framework may be robust, adaptive, and capable of dynamically adjusting to evolving conditions of a real-world enterprise environment by addressing associated multifaceted challenges and providing a path towards efficient, and adaptive management of the real-world enterprise environment.

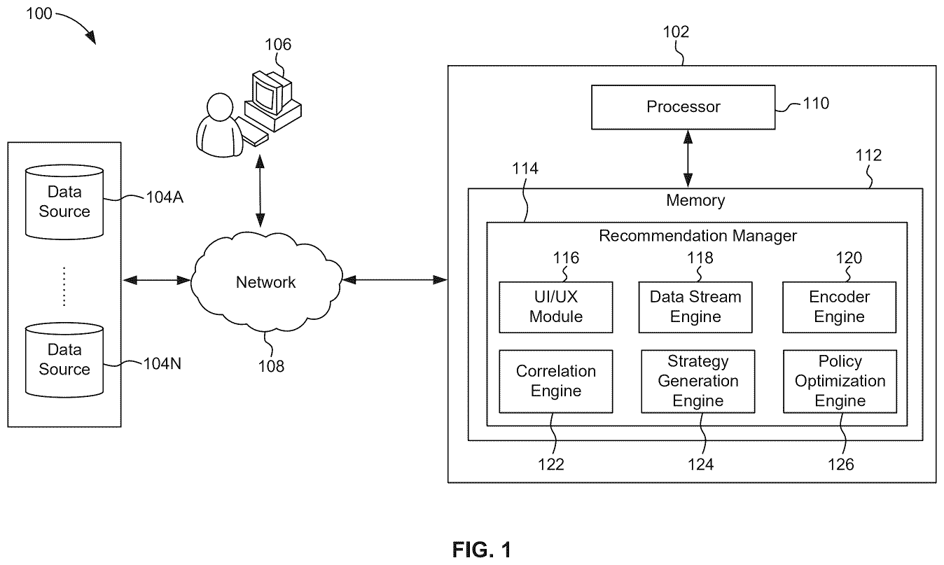

FIG. 1 depicts an exemplary environment 100 used to execute implementations of the present disclosure. The exemplary environment 100, depicted in FIG. 1, includes a system 102 (e.g., a cloud management system), data sources 104a-104n, and a user device 106. The system 102 may be communicatively coupled with the data sources 104a-104n and the user device 106 using a network 108. In some examples, the network 108 may include, but is not limited to, a Local Area Network (LAN), a Wide Area Network (WAN), the Internet, or a combination thereof. In some other examples, the network 108 may be accessed over a wired and/or a wireless communication link.

The data sources 104a-104n may act as storage repositories for storing multi-modal datasets (also be referred to as multi-modal data). The multi-modal datasets may include datasets captured from different domains of an enterprise. The different domains may correspond to functions being implemented within the enterprise. Non limiting examples of the functions may include financial operations, security operations, agility operations, technical operations (e.g., IT related operations), and/or the like. Non-limiting examples of the domains may include financial systems, security tools, performance monitoring systems, project management platforms, various databases of the enterprise, and/or the like. The functions of the enterprise may be performed using computing resources provided by cloud computing platforms/cloud service providers. In some examples, the computing resources (also referenced herein as cloud resources, cloud computing resources, or the like) may include network resources, data storage, servers, applications, and services. Example of the network resources may include routers, bandwidth, network management software, and/or the like. Examples of the data storage may include storage resources, memory, Random Access Memory (RAM), databases, and/or the like. Examples of the servers may include processors, hardware servers, Virtual Machines (VMs), hypervisor, containers, and/or the like. Examples of the applications and services may include email applications, data collection/processing applications, accounting applications, Human Resource (HR) related applications, medical related applications, and/or the like.

In some examples, the multi-modal datasets may include the datasets associated with different formats such as text files, image files, video files, audio files, log files, Application Programming Interface (API) files, configuration files, and/or a combination thereof.

The user device 106 may be associated with a user (e.g., an IT administrator, an IT leader, and/or the like) of the enterprise. In some examples, the user device 106 may include a desktop, smartphones, laptops, a tablet, and/or the like. The user device 106 may present one or more user interfaces (e.g., Graphical User Interfaces (GUIs)) of a workspace for the user to interact with the system 102 for recommendations to perform one or more actions. The one or more actions may correspond to cloud management actions that include optimizing allocation or utilization of the computing resources, enhancing security measures, reducing budget/cost associated with utilization of the computing resources, improving performance and efficiency of the technical operations, and/or the like. As would be understood, the terms “actions” and “cloud management actions” are used interchangeably throughout the document.

The system 102 may generate the recommendations for performing the one or more actions. In some examples, the system 102 may be implemented as an on-premises system. In some other examples, the system 102 may be implemented as an off-premises system (for example, a cloud or an on-demand system). Additionally, or alternatively, the system 102 may be implemented in a cloud environment. For simplicity, the system 102 depicted in FIG. 1 may be a cloud environment that is intended to represent various forms of servers including a web server, an application server, a proxy server, a network server, a server pool, and/or the like.

In some examples, the system 102 may be implemented by way of a single device or a combination of multiple devices that may be operatively connected or networked together. The system 102 may be implemented in hardware or a suitable combination of hardware and software. The “hardware” may include a combination of discrete components, an integrated circuit, an application-specific integrated circuit, a field-programmable gate array, a digital signal processor, or other suitable hardware. The “software” may include one or more objects, agents, threads, lines of code, subroutines, separate software applications, or other suitable software structures operating in one or more software applications.

The system 102 includes a processor 110 and a memory 112. The processor 110 may include one or more processors. Examples of the processor 110 may include but are not limited to, microprocessors, microcomputers, microcontrollers, digital signal processors, central processing units, state machines, logic circuits, Application Specific Integrated Circuits (ASICs), Field Programmable Gate Arrays (FPGAs), and/or any devices that manipulate data or signals based on operational instructions. The processor 110 may be communicatively coupled with the memory 112. Further, the processor 110 may be configured to execute instructions (also referenced herein as processor-executable instructions) for generating the recommendations to perform the one or more actions. The memory 112 may be non-volatile or non-transitory computer-readable medium, such as a magnetic disk or solid-state non-volatile memory or volatile medium such as Random Access Memory (RAM), and/or the like. Further, the system 102 includes a recommendation manager 114. The recommendation manager 114 may be stored in the memory 112 as downloadable libraries including the instructions. For example, as depicted in FIG. 1, the recommendation manager 114 includes a User Interface (UI)/User Experience (UX) module 116, a data stream engine 118, an encoder engine 120, a correlation engine 122, a strategy generation engine 124, and a policy optimization engine 126.

In an example implementation, the processor 110 may execute the data stream engine 118 to receive the multi-modal datasets from the data sources 104a-104n and preprocess the received multi-modal datasets. Preprocessing the multi-modal datasets may include normalizing the multi-modal datasets into a specific data format.

In an example implementation, the processor 110 may execute the encoder engine 120 to encode the preprocessed multi-modal datasets into latent vectors. The latent vectors represent essential features of the multi-modal datasets.

In an example implementation, the processor 110 may execute the correlation engine 122 to determine correlations between the multi-modal datasets based on the encoded latent vectors. The feature vectors may represent relationships and dependencies between each of the multi-modal datasets.

In an example implementation, the processor 110 may execute the strategy generation engine 124 to generate one or more decision-making strategies for each of the multi-modal datasets based on the correlations between the multi-modal datasets.

In an example implementation, the processor 110 may execute the policy optimization engine 126 to modify one or more domain policies associated with the enterprise based on the generated one or more decision-making strategies and real-time feedback, and generate the recommendations for performing the one or more actions based on the modified one or more domain policies, and historical data.

In an example implementation, the processor 110 may execute the UI/UX module 116 to output the generated recommendations for performing the one or more actions on the user interface of the user device 106.

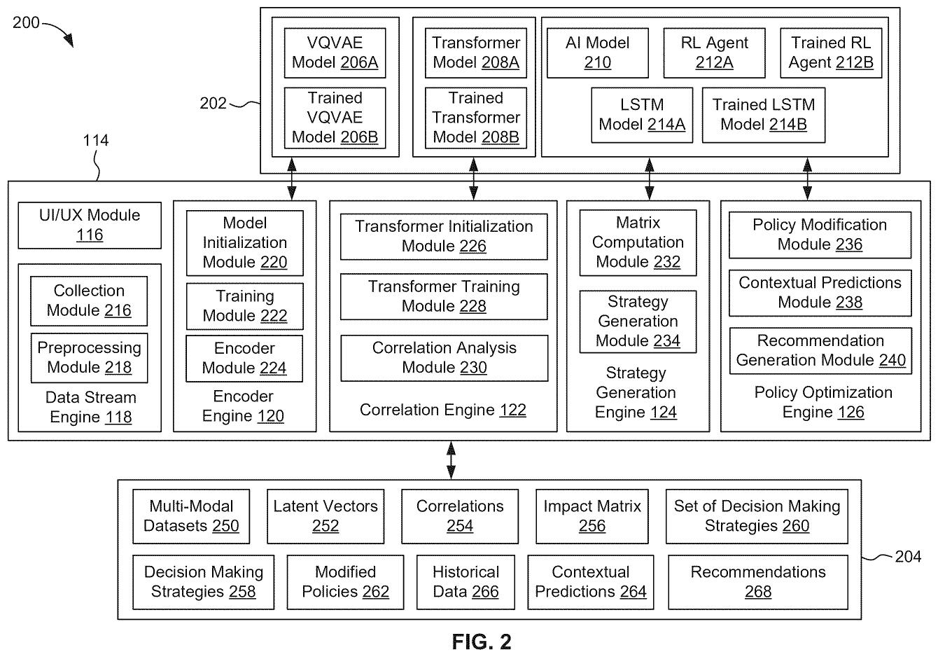

Various examples of generating the recommendations for performing the one or more actions are described in detail in conjunction with FIGS. 2-15.

FIG. 2 depicts an exemplary conceptual architecture 200 of the recommendation manager 114 of the system 102 to generate the recommendations for performing the one or more actions, in accordance with implementations of the present disclosure. As depicted in FIG. 2, the recommendation manager 114 may be communicably coupled to a model database 202 and an internal database 204. The model database 202 may store various models such as a Vector Quantized Variational Autoencoders (VQVAE) model 206A, a trained VQVAE model 206B, a transformer model 208A, a trained transformer model 208B, an Artificial Intelligence (AI) model 210, a Reinforcement Learning (RL) agent 212A (also be referred to as critic network), a trained RL agent 212B, a Long Short-Term Memory (LSTM) model 214A, a trained LSTM model 214B, and/or the like. In some examples, the various models may be AI models, machine learning (ML) models, Large Language Models (LLMs), and/or the like. The recommendation manager 114 (e.g., components 116-126 of the recommendation manager 114) may access the various models through Application Programming Interfaces (APIs) for generating the recommendations, which is described in detail below. The internal database 204 may store various data and intermediate results generated by the UI/UX module 116, the data stream engine 118, the encoder engine 120, the correlation engine 122, the strategy generation engine 124, and the policy optimization engine 126 of the recommendation manager 114.

The data stream engine 118 may capture multi-modal datasets 250 from the data sources 104a-104n and preprocess the multi-modal datasets 250 using, for example, a proprietary data extraction, transformation, and loading (ETL) method. In some examples, the ETL method may use appropriate Sequential Query Language (SQL) database tools to receive and preprocess the multi-modal datasets 250. For example, as depicted in FIG. 2, the data stream engine 118 includes a collection module 216 and a preprocessing module 218.

The collection module 216 may receive/extract the multi-modal datasets 250 from the data sources 104a-104n. The multi-modal datasets 250 may include datasets captured from the different domains and associated with different modalities. The different domains may correspond to different functions being performed on a real-world enterprise environment being hosted by the enterprise. As a non-limiting example, the real-world enterprise environment may include an Information Technology (IT) environment. The different functions may be performed for data processing, data storage, application hosting, and/or the like. Non-limiting examples of the different functions may include financial operations, security operations, technical operations, agility operations, and/or the like. In some examples, the multi-modal datasets 250 may include financial reports, internal APIs, security logs, performance metrics, project management logs, and/or the like.

In some examples, the collection module 216 may receive/extract the multi-modal datasets continuously, or based on predefined time intervals (e.g., weekly, monthly, and/or the like), or based on occurrence of events. By way of non-limiting example, the events may indicate one or more of: a change in conditions and complexities of the real-world enterprise environment, a change in conditions and complexities of the cloud computing platforms, change in agreements made with the cloud computing platforms for the computing resources, and/or the like. Receiving/extracting the multi-modal datasets 250 at the predefined time intervals may facilitate temporal analysis and trend identification. In some examples, the collection module 216 may receive/extract the multi-modal datasets 250 based on a recommendation request received from the user device 106 through the UI/UX module 116. The recommendation request may include a request for the recommendations to perform the one or more actions. The collection module 216 may provide the received multi-modal datasets 250 to the preprocessing module 218.

The preprocessing module 218 may preprocess the multi-modal datasets 250. Preprocessing of the multi-modal datasets 250 may involve transforming the multi-modal datasets 250 into a structured and processed format. In some examples, the preprocessing module 218 may use Python libraries such as Pandas and NumPy for preprocessing the multi-modal datasets 250.

The preprocessing module 218 may preprocess the multi-modal datasets 250 by removing inconsistencies from the multi-modal datasets 250 and normalizing the multi-modal datasets 250. Removing inconsistencies may include eliminating duplicate data from the multi-modal datasets 250, addressing missing values in the multi-modal datasets 250, and rectifying any data inconsistencies in the multi-modal datasets 250. Removing inconsistencies may ensure integrity and quality of the multi-modal datasets 250. Normalizing the multi-modal datasets 250 may include converting the multi-modal datasets 250 into a specified or standardize data formats. For example, normalizing the multi-modal datasets 250 may include converting different currencies in financial reports to a common currency or a specified currency unit. Therefore, normalizing the multi-modal datasets 250 may ensure data uniformity and quality across the multi-modal datasets 250.

Upon preprocessing the multi-modal datasets 250, the preprocessing module 218 may store or load the multi-modal datasets 250 into the internal database 204. By way of non-limiting example, the preprocessing module 218 may store or load the multi-modal datasets into the internal database 204 using database management systems such as PostgreSQL, which may ensure efficient access of the multi-modal datasets 250 (e.g., preprocessed multi-modal datasets) for further processing. Alternatively, upon preprocessing, the preprocessing module 218 may provide the multi-modal datasets 250 to the encoder engine 120.

The encoder engine 120 may generate the trained VQVAE model 206B by training the VQVAE model 206A and use the trained VQVAE model 206B to convert the multi-modal datasets 250 (preprocessed multi-modal datasets) into latent vectors 252 (also be referred to as encoded data). For example, as depicted in FIG. 2, the encoder engine 120 includes a model initialization module 220, a training module 222, and an encoder module 224.

The model initialization module 222 may initialize the VQVAE model 206A by defining components for the VQVAE model 206A. The defined components of the VQVAE model 206A may include an encoder, a codebook (embedding space), and a decoder. The encoder may include multiple convolutional layers. The encoder may be used to process given input data (e.g., the multi-modal datasets 250) through the multiple convolutional layers, reducing spatial dimensions of the input data and increasing a feature depth of the input data. Processing of the given input data may result in continuous latent vectors. The continuous latent vectors may be quantized to nearest codebook vectors in the codebook. The codebook may include a fixed number of vectors (e.g., 512 vectors) each with a specified dimensionality (e.g., 64). The decoder includes transposed convolutional layers. The decoder may use the transposed convolutional layers to reconstruct the given input data from the quantized nearest codebook vectors. The reconstructed input data may be used to generate output data. The output data may include latent vectors corresponding to the reconstructed input data.

Additionally, or alternatively, the model initialization module 220 may split the multi-modal datasets 250 into training datasets and encoder datasets. The training datasets may include at least some part of the multi-modal datasets 250 and may be used for training of the VQVAE model 206A. The encoder datasets may include the multi-modal datasets 250 (entire preprocessed multi-modal datasets) as new datasets to be encoded. The model initialization module 220 may provide the training datasets and the encoder datasets to the training module 222 and the encoder module 224, respectively.

The training module 222 may generate the trained VQVAE model 206B by training the VQVAE model 206A. The VQVAE model 206A may be trained based on the training datasets (that have been created from the multi-modal datasets), a reconstruction loss, and a commitment loss. For training the VQVAE model 206A, the training module 222 may provide the training datasets to the VQVAE model 206A and enable the VQVAE model 206A to learn compressed representation of the training datasets and reconstruct the training datasets by minimizing information loss while encoding high-dimensional data of the training datasets into latent vectors with low-dimensional latent space. Once the training datasets are reconstructed from training of the VQVAE model 206A, the training module 222 may compute the reconstruction loss and the commitment loss. The reconstruction loss may be computed by measuring a difference between the training datasets and the reconstructed training datasets. By way of non-limiting example, the reconstruction loss may be computed using Mean Squared Error (MSE) or similar metrics. The reconstruction loss may be used to enable the VQVAE model 206A for accurate reconstruction of the training datasets. The commitment loss (e.g., regularization term) may enable the encoder of the VQVAE model 206A to use the codebook effectively by positioning the latent vectors close to discrete codebook vectors and reducing quantization errors, thereby the VQVAE model 206A may generate compact and efficient latent vectors.

Once the reconstruction loss and the commitment loss are computed, the training module 222 may train the VQVAE model 206A over multiple epochs to generate the trained VQVAE model 206B. Each of the epochs may represent a complete pass of the VQVAE model 206A through the entire training datasets. During each epoch, the training datasets may be divided into batches of training datasets. In some examples, the epochs and the batches of training datasets may be defined based on complexity of the training datasets and availability of computational resources for training of the VQVAE model 206A. The computational resources may refer to resources of the system 102 such as processing resources, memory resources, communication resources, and/or the like, available for performing various operations by the components of the system 102 according to the present disclosure.

For each batch of training datasets, the training module 222 may compute the reconstruction loss and the commitment loss, perform backpropagation to compute gradients, determine and model weights of the VQVAE model 206A using an Adam optimizer function. The training module 222 may train the VQVAE model 206A based on each batch of training datasets by tuning model parameters (e.g., a learning rate) based on the computed gradients and updating model weights of the VQVAE model 206A based on the respectively determined model weights. After each epoch, the training module 222 may evaluate and validate performance of the VQVAE model 206A by tracking convergence of the reconstruction loss and the commitment loss. Training of the VQVAE model 206A may continue until convergence of the reconstruction loss and the commitment loss, or until determining that further epochs achieve minimal improvements, or until reaching predefined maximum epochs. Training of the VQVAE model 206A over the multiple epochs may generate the trained VQVAE model 206B by optimizing performance and balancing computational efficiency of the VQVAE model 206A. Therefore, the trained VQVAE model 206B may encode given input data (e.g., the encoder datasets) efficiently, preserving essential features of the input data while reducing dimensionality and enabling further analysis of the input data. The training module 222 may store the trained VQVAE model 206B in the model database 202.

The encoder module 224 may convert the encoder datasets (the multi-modal datasets 250) including high dimensional datasets into the latent vectors 252 with low-dimensionality, thereby converting the multi-modal datasets 250 into the latent vectors 252. The encoder module 224 may provide the encoder datasets to the encoder of the trained VQVAE model 206B. The encoder may use the multiple convolutional layers to identify hierarchical features within the encoder datasets by transforming the encoder datasets into a continuous latent space. The identified hierarchical features may be quantized into nearest codebook vectors in the codebook of the trained VQVAE model 206B using codebook parameters. The codebook parameters may include a number of embeddings (k) and a dimensionality of each embedding vector (D). The quantized nearest codebook vectors may be provided to the decoder of the trained VQVAE model 206B. The decoder may use the transposed convolutional layers to generate/encode the latent vectors 252 by reconstructing the encoder datasets from the quantized nearest codebook vectors. The latent vectors 252 may indicate the essential features of the encoder datasets/multi-modal datasets 250 in a low-dimensional space. The latent vectors 252 corresponding to the multi-modal datasets 250 may be stored in the internal database 204 and/or provided to the correlation engine 122.

The correlation engine 122 may generate the trained transformer model 208B by training the transformer model 208A and use the trained transformer model 208B to determine correlations 254 between the multi-modal datasets 250 based on the latent vectors 252 of the multi-modal datasets 250. For example, as depicted in FIG. 2, the correlation engine 122 includes a transformer initialization module 226, a transformer training module 228, and a correlation analysis module 230.

The transformer initialization module 226 may initialize the transformer model 208A by defining components for the transformer model 208A. The components of the transformer model 208A may include an input layer, an encoder layer, and an output layer. The input layer may receive the latent vectors 252 of the multi-modal datasets 250 from the encoder engine 120. The input layer may include a dimensionality matching the dimensionality of the latent vectors 252. The input layer may forward the latent vectors 252 to the encoder layer. The encoder layer may include self-attention layers, feedforward layers, and add and normalization layers. The encoder layer may utilize the self-attention layers with a multi-head self-attention mechanism to process the latent vectors 252 of the multi-modal datasets 250 and capture dependencies across the multi-modal datasets 250. The feedforward layers may apply a fully connected feed-forward network to an output of the self-attention layers to enhance extraction of the features from the multi-modal datasets. The output layer may generate feature vectors representing learned correlations between the multi-modal datasets.

The transformer training module 228 may generate the trained transformer model 208B by training the transformer model 208A based on the latent vectors 252 of the multi-modal datasets 250. The transformer training module 228 may provide the latent vectors 252 of the multi-modal datasets 250 to the transformer model 208A and train the transformer model 208A to predict correlation feature vectors from the latent vectors 252 of the multi-modal datasets 250. The correlation feature vectors may predict correlations between the multi-modal datasets 250. Once the correlation feature vectors are predicted using the transformer model 208A, the transformer training module 228 may determine ground truth correlation feature vectors using statistical measures. The statistical measures may include measurement of linear correlation/association between the multi-modal datasets 250 based on the respective encoded latent vectors 252. Non-limiting examples of the statistical measures may include Pearson correlation, Spearman correlation, and/or the like. The transformer training module 228 may further determine attention weights of the self-attention layers, which are being used by the encoder layer of the transformer model 208A. Optionally, the transformer training module 228 may determine target attention weights based on domain-specific insights or predefined attention patterns.

Based on one or more of: the predicted correlation feature vectors, the ground truth correlation feature vectors, the attention weights, and the target attention weights, the transformer training module 228 may determine loss functions. The loss functions may ensure accurate prediction of the correlation feature vectors, regularization to overfitting, and alignment of the attention weights with the domain-specific insights or cross-domain insights. Therefore, the loss functions may enable the transformer model 208A to accurately predict and represent complex and cross-domain correlations among the multi-modal datasets of the different domains, while ensuring that the predicted correlations reflect true underlying relationships between the multi-modal datasets. In some examples, the loss functions may include one or more of: a correlation alignment loss function, an attention alignment loss function, and a regularization loss function.

The correlation alignment loss may ensure that the predicted correlation feature vectors match the ground truth correlation feature vectors. In an example, the correlation alignment loss (CAL) may be determined as:

$$CAL = ( \frac{1}{N \times M} ) {\sum }_{i = 1}^{N} {\sum }_{j = 1}^{M} {( {C}_{pred [ j ] ( i )} - {C}_{tru e [ j ] [ i ]} )}^{2}$$

wherein, ‘C_{pred[j](i)}’ may represent the correlation feature vectors, ‘C_{true[i][i]}’ may represent the ground truth correlation feature vectors, ‘N’ may represent a number of data samples (e.g., the multimodal datasets), and ‘M’ may represent a number of domains from which the multi-modal datasets have been received.

The attention alignment loss may enable the encoder layer of the transformer model 208A to consider the relevant domain-specific insights or cross-domain interactions for processing the latent vectors 252 of the multi-modal datasets 250. Therefore, accuracy and interpretability of predicting the correlation feature vectors may be enhanced. In an example, the attention alignment loss (AAL) may be determined as:

$$AAL = ( \frac{1}{N \times H \times M} ) {\sum }_{i = 1}^{N} {\sum }_{h = 1}^{H} {\sum }_{j = 1}^{M} {( {A}_{pred [ h ] [ j ] ( i )} - {A}_{target [ h ] [ j ] [ i ]} )}^{2}$$

wherein, ‘A_{pred[h][j](i)}’ may represent the attention weights, ‘A_{target[h][j][i]}’ may represent the target attention patterns, and ‘H’ may represent a number of heads included in the self-attention layers of the transformer model 208A.

The regularization loss function may prevent overfitting by penalizing large weights of the transformer model 208A. In an example, the regularization loss function (RL) may be determined as:

$$R L = λ \sum ( k ) {W}_{k}^{2}$$

wherein, ‘λ’ may represent a regularization coefficient (e.g., hyperparameter controlling regularization capability) and

$$‘ ( k ) {W}_{k}^{2} ’$$

may represent model weights of the transformer model 208A at a layer ‘k’.

Based on the determined loss functions, the transformer training module 228 may compute a final loss function (L) as:

$$L = α * CAL + β * AAL + γ * R L$$

wherein, ‘α’, ‘β’ and ‘γ’ may represent a set of model hyperparameters of the transformer model 208A that may balance importance/contribution of each of the correlation loss function, the attention alignment loss function, and the regularization loss function.

Using the final loss function, the transformer training module 228 may determine the set of model hyperparameters for tuning. By way of non-limiting example, the transformer training module 228 may determine values of ‘α’ and ‘β’ to 0.1 and may determine to tune ‘γ’ based on regularization requirements.

In some examples, the transformer training module 228 may tune/train the transformer model 208A over multiple epochs to minimize the final loss function. Each of the epochs may represent a complete pass of the transformer model 208A through the entire latent vectors 252 of the multi-modal datasets 250. During each epoch, the latent vectors 252 of the multi-modal datasets 250 may be divided into batches of latent vectors. In some examples, the batches may depend on the complexity of the encoded latent vectors and availability of the computational resources for training of the transformer model 208A. For each batch of latent vectors, the transformer training module 228 may compute the loss functions, perform backpropagation to compute gradients, determine and model weights of the transformer model 208A using the Adam optimizer function. The transformer training module 228 may tune the transformer model 208A by tuning the model parameters (e.g., a learning rate)/hyperparameters based on the computed gradients and updating model weights of the transformer model 208A based on the respectively determined model weights. After each epoch, the transformer training module 228 may evaluate and validate performance of the transformer model 208A by tracking convergence of the loss functions. Tuning/training of the transformer model 208A may continue until minimizing the loss functions or until determining that further epochs achieve minimal improvements, or until reaching predefined maximum epochs. Tuning/training of the transformer model 208A over the multiple epochs may generate the trained transformer model 208B with optimized performance. The trained transformer model 208B with the optimized performance may efficiently learn the correlations 254 including complex correlations between the multi-modal datasets 250. The trained transformer model 208B may be stored in the model database 202.

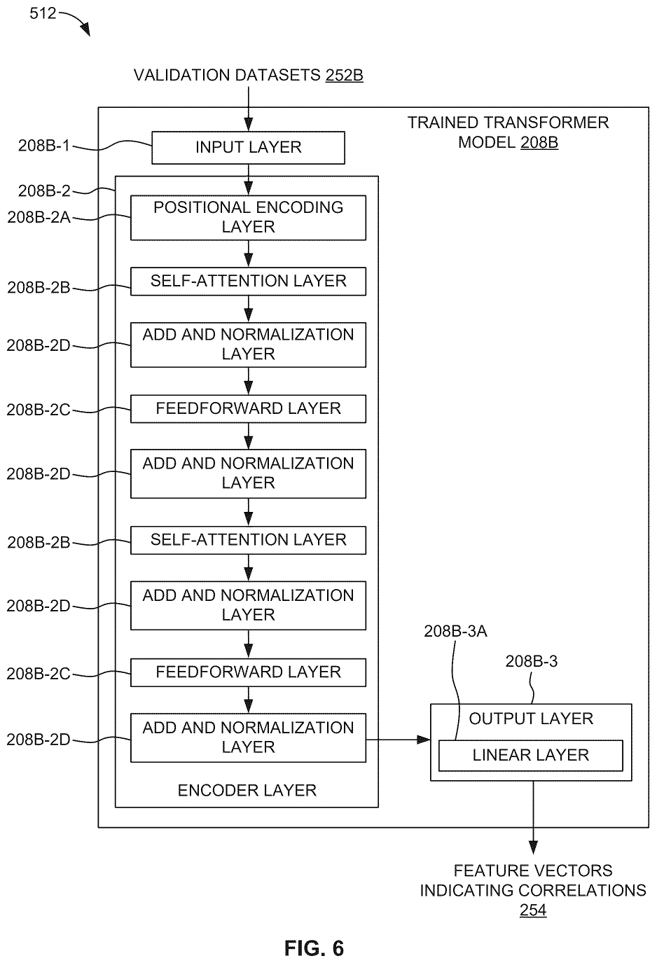

The correlation analysis module 230 may use the trained transformer model 208B to determine the correlations 254 between the multi-modal datasets 250 based on the respective latent vectors 252. The correlation analysis module 230 may provide the latent vectors 252 to the input layer of the trained transformer model 208B, which may further forward the encoded latent vectors to the encoder layer. The encoder layer may use the self-attention layers with the multi-head self-attention mechanism to determine the dependencies and relationships between each of the multi-modal datasets 250 based on the respective latent vectors 252. Based on the determined dependencies and relationships, the encoder layer may use the feedforward layers to apply the fully connected feed-forward network to an output of the self-attention layers (e.g., the dependencies and relationships) to enhance extraction of the features. The output layer of the trained transformer model 208B may generate feature vectors based on the enhanced extraction. The feature vectors may determine the correlations 254 between the multi-modal datasets 250. By way of non-limiting example, if the multi-modal datasets 250 include financial data, performance metrics, and security logs, the correlations 254 between the multi-modal datasets 250 may indicate how variations in financial data (multi-modal datasets 250 related to the financial operations) correlate with changes in the performance metrics and the security logs (multi-modal datasets 250 related to the technical operations and the security operations). An exemplary illustration of determining the correlations 254 using the trained transformer model 208B is depicted in FIG. 6. The correlations 254 between the multi-modal datasets 250 may be stored in the internal database 204 and/or may be provided to the strategy generation engine 124.

The strategy generation engine 124 may compute an impact matrix 256 based on the correlations 254 between the multi-modal datasets 250 and generate one or more decision-making strategies 258 for each of the multi-modal datasets 250 using the impact matrix 256. The one or more decision-making strategies 258 may refer to strategies indicating optimal actions and/or optimal recommendations for performing the actions that include optimizing utilization of the computing resources, while managing budget, and maintaining security, reliability, and operational efficiency of the computing resources. For example, as depicted in FIG. 2, the strategy generation engine 124 includes a matrix computation module 232 and a strategy generation module 234.

The matrix computation module 232 may compute the impact matrix 256 (also be referred to as payoff matrix, score matrix, correlation matrix, and/or the like) for the multi-modal datasets 250 based on the determined correlations 254 between the multi-modal datasets 250 using the trained transformer model 208B.

For computing the impact matrix 256, the matrix computation module 232 may identify a set of decision-making strategies 260 for each of the multi-modal datasets 250 based on the correlations 254 between the multi-modal datasets 250. The set of decision-making strategies 260 may include predefined decision-making strategies stored in the internal database 204 for various multi-modal datasets. For example, consider that the multi-modal datasets 250 include financial reports related to the financial operations and security logs related to the security operations. In such a case, the set of decision-making strategies 260 identified for the financial reports may include financial related decision-making strategies and the set of decision-making strategies 260 identified for the security logs may include security related decision-making strategies. By way of non-limiting example, the financial related decision-making strategies may include determining various budget allocations to the security operations and the security related decision-making strategies may include selecting different levels of security measures.

Once the set of decision-making strategies 260 for each of the multi-modal datasets 250 are identified, the matrix computation module 232 may identify impact metrics for each pair of decision-making strategies in the set of decision-making strategies 260 based on historical performance data and/or simulation data. The impact metrics may indicate how each decision-making strategy may impact the other. The historical performance data and/or the simulation data may be stored in the internal database 204. The historical performance data and/or the simulation data may indicate decision-making strategies used for performing previous one or more actions on the computing resources and an impact of each decision-making strategy on another.

Based on the impact metrics, the matrix computation module 232 may compute impact scores (also be referred to as correlation scores, payoff scores, impact values, and/or the like) based on co-variability of each pair of decision-making strategies in the set of decision-making strategies 260. In some examples, the matrix computation module 232 may use Pearson correlation for computing the impact scores, if the set of decision-making strategies include continuous strategies. In some other examples, the matrix computation module 232 may use one of Spearman correlation and point-biserial correlation for computing the impact scores, if the set of decision-making strategies include categorical or binary or discrete strategies. An impact score of a pair of decision-making strategies may indicate how well the respective pair of decision-making strategies may align or impact each other. The impact score may vary between ‘−1’ and ‘1’. The impact score close to ‘1’ may indicate a strong positive correlation between the respective pair of decision-making strategies. The impact score close to ‘0’ may indicate a small to no impact between the respective pair of decision-making strategies. The impact score close to ‘−1’ may indicate a negative correlation between the respective pair of decision-making strategies.

Once the impact scores are computed, the matrix computation module 232 may compute the impact matrix 256 for the multi-modal datasets 250. For computing the impact matrix 256, the matrix computation module 232 may arrange first decision-making strategies in the set of decision-making strategies 260 along rows and second decision-making strategies in the set of decision-making strategies 260 along columns. Further, the matrix computation module 232 may populate each cell (a value of each row with respect to each column) with the computed impact score corresponding to each pair of decision-making strategies, thereby providing a comprehensive view of how each pair of decision-making strategies interact. In an example, the impact matrix 256 may be computed as:

$$Impact matrix [ r , c ] = impact\_scores [ r * num\_strategies + r ] - impact\_scores [ r * num\_strategies + c ]$$

wherein, ‘num_strategies’ may represent the set of decision making strategies 260, and ‘r’ and ‘c’ may represent rows and columns of the impact matrix 256, respectively.

For example, if the set of decision-making strategies 260 include the financial related decision-making strategies and the security related decision-making strategies, the impact matrix 256 may include rows indicating the financial related decision-making strategies and columns indicating the security related decision-making strategies. Each cell (a row and a respective column) may include an impact score for both the financial related decision-making strategies and the security related decision-making strategies.

Further, the impact matrix 256 may enable evaluation of an interaction between each pair of decision-making strategies, while supporting informed decisions based on quantified relationships and dependencies between each pair of decision-making strategies. In addition, the impact matrix 256 may enable quantification of one or more actions (e.g., increased security, improved performance, improved expenditure, improved utilization of the computing resources, and/or the like) to be performed in the real-world enterprise environment with respect to each of the multi-modal datasets 250. The impact matrix 256 may be provided to the strategy generation module 234.

The strategy generation module 234 may generate the one or more decision-making strategies 258 for each of the multi-modal datasets using the impact matrix 256. The one or more decision-making strategies 258 may indicate strategies to perform the one or more actions. For example, the strategies may include adjusting budget allocation to security operations, modifying security measures, and/or the like.

For generating the one or more decision-making strategies 258, the strategy generation module 234 may determine one or more equilibrium points for the set of decision-making strategies by solving the computed impact matrix 256. The one or more equilibrium points may indicate a strategic balance where the impact scores of the impact matrix 256 attain saturation. For example, the one or more equilibrium points may include points at which unilaterally changing any pair of decision-making strategies may not improve the impact scores. Further, a pair of decision-making strategies associated with any of such impact scores may be identified as optimal decision-making strategies.

In some examples, the strategy generation module 234 may use Nash equilibrium methods such as linear programming methods, iterative best response methods, and/or the like, for determining the one or more equilibrium points by solving the impact matrix 256. The linear programming methods may be used, when the set of decision-making strategies 260 includes the continuous strategies. The iterative best response methods may be used, when the set of decision-making strategies 260 includes the categorized or binary or discrete strategies. Selectively utilizing the linear programming methods and the iterative best response methods based on a nature of the set of decision-making strategies 260 may allow the strategy generation module 234 to determine the one or more equilibrium points that are more responsive to complex, dynamic interactions in the real-world enterprise environment, and making the real-world enterprise environment ideal for strategic optimization in real-time, and data-rich scenarios.

In some other examples, the strategy generation module 234 may use python libraries such as SciPy and NumPy for determining the one or more equilibrium points by solving the impact matrix 256. By way of non-limiting example, consider that the set of decision-making strategies 260 include the financial related decision-making strategies and the security related decision-making strategies. The financial related decision-making strategies may include allocating budget of 20%, 25%, and 35% to security operations. The security related decision-making strategies may include assigning basic, intermediate, and advanced security protocols or measures for the security operations. In such a scenario, allocating 25% of budget to the security operations while implementing intermediate security protocols may be determined as an equilibrium point where unilateral changes in the financial related decision-making strategies and the security related decision-making strategies may not further improve the respective impact scores.

The strategy generation module 234 may identify an appropriate decision-making strategy from the set of decision-making strategies 260 based on the determined one or more equilibrium points. Based on the appropriate decision-making strategy, the strategy generation module 234 may generate the one or more decision-making strategies 258 for each of the multi-modal datasets. The one or more decision-making strategies 258 generated for each of the multi-modal datasets may be stored in the internal database 204 and/or may be provided to the policy optimization engine 126.

The policy optimization engine 126 may generate modified one or more domain policies 262 based on the one or more decision-making strategies 258, determine contextual predictions 264 from historical data 266, and integrate the modified one or more domain policies 262 with the contextual predictions 264 to generate recommendations 268 for performing one or more actions. For example, as depicted in FIG. 2, the policy optimization engine 126 includes a policy modification module 236, a contextual predictions module 238, and a recommendation generation module 240.

The policy modification module 236 may generate the modified one or more domain policies 262 by processing the generated one or more decision-making strategies 258 and real-time feedback using the AI model 210 (also be referred to as policy network).

For generating the modified one or more domain policies 262, the policy modification module 236 may determine a state space layer of the AI model 210 based on the generated one or more decision-making strategies 258 and metrics representing a current state of the real-world enterprise environment. Therefore, the state space layer of the AI model 210 may include the metrics representing the current state of the real-world enterprise environment. Non-limiting examples of the metrics may include a budget allocation (e.g., percentage of budget allocated to the security operations), a system performance (e.g. uptime, response time, and/or the like), security incidents (e.g., a number of incidents), project progress (e.g., sprint velocity), and/or the like. Once the state space layer of the AI model 210 is determined, the policy modification module 236 may determine an action space layer of the AI model 210 based on the generated one or more decision-making strategies 258. The action space layer may predict the one or more actions to be performed. The one or more actions to be performed may include adjusting utilization of the computing resources, adjusting budget allocations, implementing various security measures/protocols, modifying timelines of projects, and/or the like. Further, the policy modification module 236 may compute a reward function indicating feedback on outcomes of the predicted actions based on the determined action space layer and the state space layer. The reward function may be computed to maximize performance metrics, minimize costs, and security incidents. The reward function may include a positive reward and a negative reward. For example, an increase in system uptime and reduction in security incidents may result in the positive reward, while increased costs or project delays may result in the negative reward.

The policy modification module 236 may generate a simulation environment (also be referred to as RL environment) of the enterprise emulating the real-world enterprise environment using real-world constraints and dynamics and based on the state space layer and action space layer of the AI model 210 and the computed reward function.

Upon generating the simulation environment, the policy modification module 236 may generate the trained RL agent 212B by training the RL agent 212A. For generating the trained RL agent 212B, the policy modification module 236 may provide information related to the state space layer and the action layer to the RL agent 212A and initialize the RL agent 212A with the metrics representing the current state and/or complexity of the real-world enterprise environment. Upon initializing the RL agent 212A, the policy modification module 236 may generate training episodes (also be referred to epochs/iterations) in the simulated environment. The training episodes may indicate a complete sequence of steps from a start state to a terminal state in the simulated environment. Once the training episodes are generated, the policy modification module 236 may train the RL agent 212A by executing the training episodes, where the RL agent 212A may be enabled to learn optimal domain policies associated with the enterprise by interacting with the simulation environment, performing the actions, and receiving reward functions. The optimal domain policies may enable dynamic adjustments to budget allocations, security measures, project timelines, and/or the like. In some examples, the policy modification module 236 may train the RL agent 212A using training methods such as deep Q-learning methods, actor-critic methods, and/or the like. The policy modification module 236 may train the RL agent 212A using the deep Q-learning methods to estimate an expected cumulative reward for each pair of state and action. The policy modification module 236 may train the RL agent 212A using the actor-critic methods to select the actions and critics to evaluate the actions. In some examples, the policy modification module 236 may use ML libraries such as PyTorch to optimize training of the RL agent 212A using the training methods. The policy modification module 236 may continuously update the learned domain policies by the RL agent 212A and improve the decision-making strategies based on the accumulated learning. Training of the RL agent 212A may result in generation of the trained RL agent 212B. The trained RL agent 212B may be stored in the model database 202.

Once the trained RL agent 212B is generated, the policy modification module 236 may generate multiple training datasets corresponding to the generated one or more decision-making strategies 258 by simulating the trained RL agent 212B in the generated simulation environment. The training datasets may indicate reward functions computed for actions predicted from simulation of the trained RL agent 212B and a next state of the simulation environment of the enterprise. Based on the training datasets, the policy modification module 236 may predict multiple actions and an outcome of each action. The policy modification module 236 may determine the one or more domain policies associated with the enterprise required to be modified based on the predicted actions and the corresponding outcomes. The one or more domain policies may include the optimal actions from the predicted actions. The optimal actions may be determined based on reward functions determined for the outcomes corresponding to the predicted actions. Based on the determination, the policy modification module 236 may generate the modified one or more domain policies 262 by modifying the determined one or more domain policies. In some examples, the policy modification module 236 may continuously modify the determined one or more domain policies to incorporate new training datasets and observed outcomes. Such a continuous modification of the one or more domain policies may ensure that the trained RL agent 212B adapts to changing conditions of the real-world enterprise environment by maintaining optimal performance. In some other examples, the policy modification module 236 may also capture real-time feedback and performance metrics associated with the real-world enterprise environment. The real-time feedback and the performance metrics may be received from the user through the user device 106. The real-time feedback may include positive feedback or negative feedback on the optimal policies included in the one or more domain policies. The performance metrics may describe performance of the trained RL agent 212B according to the user. Based on the real-time feedback and the performance metrics, the policy modification module 236 may periodically modify the determined one or more domain policies. The modified one or more domain policies 262 may result in optimized domain policies for generating the recommendations. The policy modification module 236 may store the modified one or more domain policies 262 in the internal database 204 and/or provide the modified one or more domain policies 262 to the recommendation generation module 240.

The contextual prediction module 238 may generate the trained LSTM model 214B by training the LSTM model 214A and use the trained LSTM model 214B to determine the contextual predictions 264 using the historical data 266.

For determining the contextual predictions 264, the contextual prediction module 238 may obtain the historical data 266 corresponding to the enterprise from the data sources 104a-104n and/or from the internal database 204. In some examples, the historical data 266 may include previous data such as financial allocations, system performance metrics, security incidents, project management data, and/or the like. Once the historical data is obtained, the contextual prediction module 238 may define components for the LSTM model 214A. The components of the LSTM model 214A may include input and output layers for historical representations, LSTM layers for capturing temporal dependencies, and dense layers for predicting temporal patterns and anomalies and forecasted values. Upon defining the components of the LSTM model 214A, the contextual prediction module 238 may structure the obtained historical data 266 into sequences (e.g., monthly budget allocations, monthly security incidents, and/or the like) suitable for time series analysis.

The contextual prediction module 238 may generate the trained LSTM model 214B by training the LSTM model 214A using the sequences of the historical data 266 to predict temporal patterns (trends) and anomalies and forecasted values. In some examples, the LSTM model 214A may be trained using ML libraries such as PyTorch to generate the trained LSTM model 214B. The trained LSTM model 214B may be stored in the model database 202.

Once the trained LSTM model 214B is generated, the contextual prediction module 238 may provide the historical data 266 and the metrics representing the current state of the real-world enterprise environment to the trained LSTM model 214B and enable the trained LSTM model 214B to determine the contextual predictions 264 by preprocessing timeseries data of the historical data 266. The contextual predictions 264 may predict the temporal patterns and the anomalies and forecasted values for the obtained historical data 266. The contextual predictions 264 may be stored in the internal database 204 and/or may be provided to the recommendation generation module 240.

The recommendation generation module 240 may generate the recommendations 268 for performing the one or more actions by integrating and analyzing the modified one or more domain policies 262 and the contextual predictions 264. The recommendations 268 may include insights or suggestions for performing the one or more actions/cloud management actions.

For generating the recommendations 268, the recommendation generation module 240 may compute a first confidence score (also be referred to as RL confidence score) for the modified one or more domain policies 262 based on the performance of the trained RL agent 212B over execution of the latest episodes in the simulated environment. The performance of the trained RL agent 212B may indicate reward consistency and stability of the one or more domain policies. In some examples, the recommendation generation module 240 may use moving averages and standard deviations of the reward functions determined during the latest episodes for computing the first confidence score.

The recommendation generation module 240 may compute a second confidence score (e.g., LSTM confidence score) for the contextual predictions 264 (includes predicted temporal patterns and the anomalies and the forecasted values) based on prediction accuracy, error margins (e.g., Mean Absolute Error), and consistency/variance of historical data trends of the trained LSTM model 214B.

The recommendation generation module 240 may further compute a first weight (e.g., RL weight) for the modified one or more domain policies 262 based on the first confidence score and the second confidence score. In an example, the first weight may be computed as:

$$First weight = ( \frac{First confidence score}{First confidence score} + Second confidence score )$$

The recommendation generation module 240 may further compute a second weight (e.g., LSTM weight) for the contextual predictions 264 based on the second confidence score and the first confidence score. In an example, the second weight may be computed as:

$$Second weight = ( \frac{Second confidence score}{First confidence score} + Second confidence score )$$

Based on the first confidence score, the second confidence score, the first weight, and the second weight, the recommendation generation module 240 may compute a final output. The final output may indicate a weighted average of the first weight and the second weight, which may ensure that both short-term actions and long-term terms are considered for generating the recommendations. In an example, the final output may be computed as:

$$Final output = ( \frac{First confidence score}{First confidence score} + Second confidence score * First weight ) + ( \frac{Second confidence score}{First confidence score} + Second confidence score * Second weight )$$

By way of non-limiting example, if the first confidence score and the second confidence score include 0.8 and 0.6, respectively, and the first weight and the second weight may include 0.57 and 0.43, respectively, the final output may be computed as 26.85%.

The recommendation generation module 240 may further use the final output to generate the recommendations 268 for performing the one or more actions. The recommendations 268 for performing the one or more actions may include enabling dynamic adjustments to budget allocations, security measures, and project timelines based on real-time feedback and continuous learning. To illustrate, the recommendation generation module 240 may compare the final output with a predefined threshold score. Based on the comparison, the recommendation generation module 240 may determine to generate the recommendations by adjusting the modified one or more domain policies 262 generated using the trained RL agent 212B based on the contextual predictions 264 determined using the trained LSTM model 214B. By way of non-limiting example, consider that the modified one or more domain policies 262 generated using the trained RL agent 212B indicate 25% budget allocation to security operations and the contextual predictions 264 determined using the trained LSTM model 214B indicate an increase in security incidents. Further, the final output/weighted average computed with respect to the modified one or more domain policies 262 and the contextual predictions 264 exceeds the predefined threshold score. In such a scenario, the recommendation generation module 240 may generate the recommendations 268 by adjusting the modified one or more domain policies 262 (e.g., indicating 26% budget allocation to the security operations) to reflect long-term trends (e.g., increase in the security incidents) determined through the contextual predictions 264.

The UI/UX module 116 may output the generated recommendations 268 for performing the one or more actions on the user interface of the user device 106. In some examples, the UI/UX module 116 may generate multiple simpler visualizations corresponding to the recommendations. The multiple simpler visualizations may be outputted on the user interface of the user device 106, which may allow the user to efficiently explore the recommendations 268.

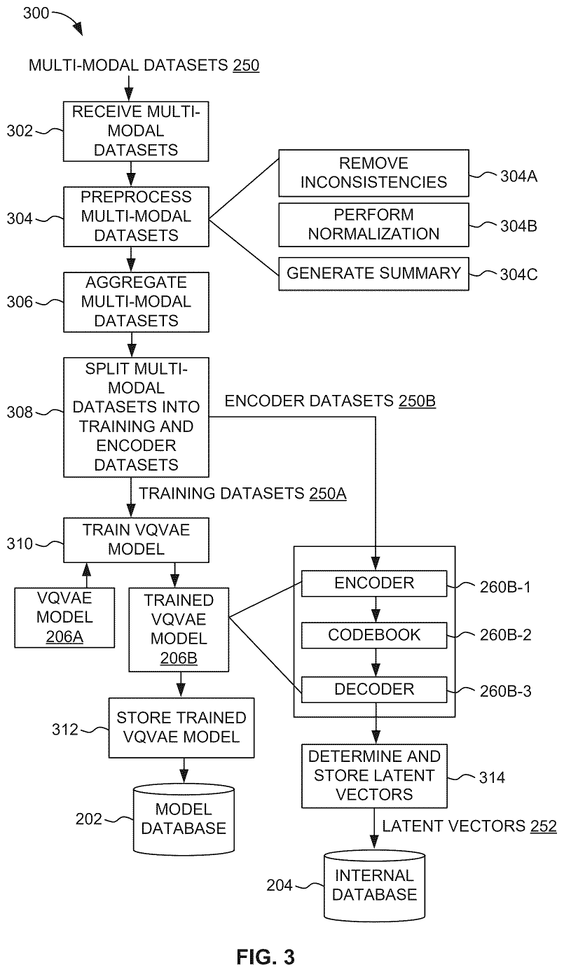

FIG. 3 is an exemplary flow diagram presenting a method 300 for encoding the multi-modal datasets 250 into the latent vectors 252, in accordance with implementations of the present disclosure. In some implementations, the method 300 may be executed by the processor 110 of the system 102 using the data stream engine 118 and the encoder engine 120, as described in relation to FIGS. 1 and 2.

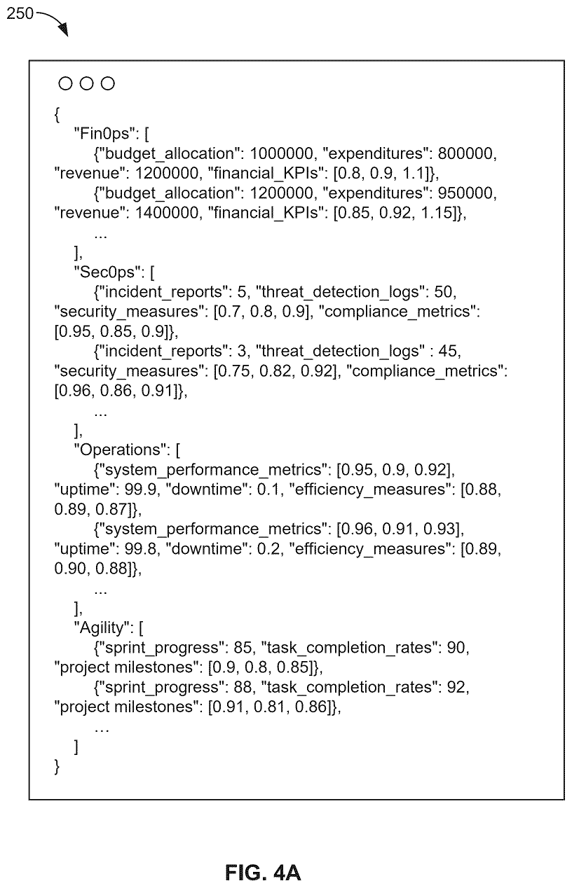

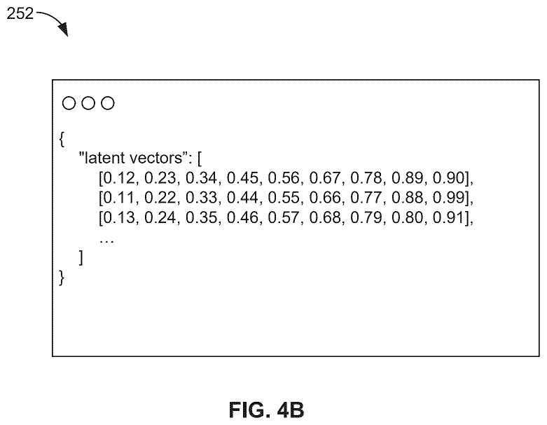

At step 302, the method 300 includes receiving the multi-modal datasets 250 from the data sources 104a-104n. The multi-modal datasets 250 may be related to the different domains of the enterprise. The different domains may correspond to the functions being performed by the enterprise such as financial operations, security operations, technical operations, agility operations. The multi-modal datasets 250 related to the financial operations may include financial operations data such as budget allocation, expenditures, revenue and financial Key Performance Indicators (KPIs), and/or the like. The multi-modal datasets 250 related to the security operations may include security operations data such as incident reports, threat detection logs, security measures, efficiency measures, and/or the like. The multi-modal datasets 250 related to the technical operations may include operations data such as system performance metrics, uptime, downtime, efficiency measures, and/or the like. The multi-modal datasets 250 related to the agility operations may include project management data such as sprint progress, task completion rates, project milestones, and/or the like. Exemplary multi-modal datasets 250 related to the financial operations (FinOps), the security operations (SecOps), the technical operations (Operations), and the agility operations (Agility) are depicted in FIG. 4A.

At step 304, the method 300 incudes preprocessing the multi-modal datasets 250. For preprocessing the multi-modal datasets 250, at step 304A, the method 300 includes removing the inconsistencies from the multi-modal datasets 250 such as eliminating duplicate data from the multi-modal datasets 250, addressing missing values in the multi-modal datasets 250, and rectifying any data inconsistencies in the multi-modal datasets 250. At step 304B, the method 300 includes normalizing the multi-modal datasets 250. Normalizing the multi-modal datasets 250 may include standardizing and scaling formats of the multi-modal datasets 250 to ensure uniformity across the multi-modal datasets 250. At step 304C, the method 300 includes generating a summary for the multi-modal datasets 250 for facilitating temporal analysis and trend identification. In some examples, the summary may be generated at a predefined time interval (e.g., monthly).

After preprocessing the multi-modal datasets, at step 306, the method 300 includes aggregating the multi-modal datasets 250 received from the different domains of the enterprise. At step 308, the method 300 includes splitting the multi-modal datasets 250 into training datasets 250A and encoder datasets 250B. The training datasets 250A may include at least some portions of the multi-modal datasets 250. The training datasets 250A may be used for training of the VQVAE model 206A. The encoder datasets 250B may include the aggregated multi-modal datasets to be encoded.

At step 310, the method 300 includes training the VQVAE model 206A to generate the trained VQVAE model 206B. The VQVAE model 206A may be trained based on the training datasets 250A. Training the VQVAE model 206A may include (i) enabling the VQVAE model 206A to learn to encode the training datasets 250A into a latent space (e.g., latent vectors) and to reconstruct the latent space to the training datasets, (ii) determining the reconstruction loss and the commitment loss based on the training datasets 250A and the reconstructed training datasets, and (iii) tuning/training the VQVAE model 206A over the multiple epochs to minimize the reconstruction loss and the commitment loss, thereby generating the trained VQVAE model 206B. At step 312, the method 300 includes storing the trained VQVAE model 206B in the model database 202.

At step 314, the method 300 includes determining and storing the latent vectors 252 corresponding to the multi-modal datasets 250 using the trained VQVAE model 206B in the internal database 204. The latent vectors 252 may be determined by encoding the encoder datasets 250B (e.g., the aggregated multi-modal datasets) into the latent vectors using the trained VQVAE model 206B. The encoder datasets 250B may be passed to an encoder 206B-1 of the trained VQVAE model 206B. The encoder 206B-1 may identify hierarchical features within the encoder datasets 250B by transforming the encoder datasets 250B into a continuous latent space using multiple convolutional layers. The identified hierarchical features may be quantized to a nearest codebook vectors within a codebook 206B-2 of the trained VQVAE model 206B, using codebook parameters. The codebook parameters may include a number of embedding vectors (K) and a dimensionality of each embedding vector (D). Further, a decoder 206B-3 of the trained VQVAE model 206B may generate the latent vectors 252 by reconstructing the encoder datasets from the quantized nearest codebook vectors using multiple transposed convolutional layers. The latent vectors 252 may indicate essential features of the multi-modal datasets 250 while reducing dimensionality of the multi-modal datasets 250. Exemplary latent vectors 252 corresponding to the multi-modal datasets 250 are depicted in FIG. 4B.

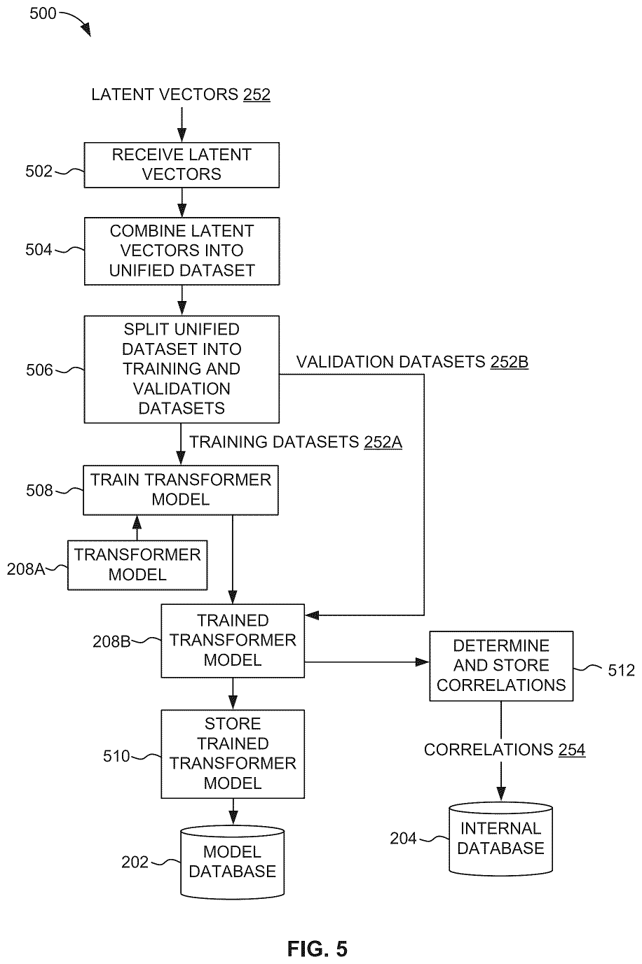

FIG. 5 is an exemplary flow diagram presenting a method 500 for determining the correlations 254 between the multi-modal datasets 250 using the respective latent vectors 252, in accordance with implementations of the present disclosure. In some implementations, the method 500 may be executed by the processor 110 of the system 102 using the correlation engine 122, as described in relation to FIGS. 1 and 2.

At step 502, the method 500 includes receiving the latent vectors 252 corresponding to the multi-modal datasets 250 from the internal database 204 or the encoder engine 120. At step 504, the method 500 includes combining the latent vectors 252 into a unified dataset. At step 506, the method 500 includes splitting the unified dataset into training datasets 252A and validation datasets 252B. The training datasets 252A may be used for training of the transformer model 208A. The validation datasets 252B may be used for validating the trained transformer model 208B. In some examples, the training datasets 252A may include 80% of datasets from the unified dataset and the validation datasets 252B may include 20% of datasets from the unified dataset.

At step 508, the method 500 includes training the transformer model 208A to generate the trained transformer model 208B. The transformer model 208A may be trained based on the training datasets 252A and the loss functions.

For example, consider the training datasets 252A include financial spend and security incidents. In such an example, the transformer training module 228 of the correlation engine 122 may provide the financial spend and the security incidents to the transformer model 208A and train the transformer model 208A to predict a correlation feature vector between the financial spend and the security incidents. In an example, the correlation feature vector may indicate a correlation of 0.68 between the financial spend and the security incidents. Further, the transformer training module 228 may determine:
(i) ground truth correlation feature vectors by performing statistical measures on historical data including the financial spend and the security incidents. The ground truth correlation feature vectors may represent a true correlation of 0.7 between the financial spend and the security incidents.
(ii) attention weights of the self-attention layers that are being used by the encoder layer of the transformer model 208A as 0.6. and
(iii) target attention weights as 0.65.

Based on the predicted correlation of 0.68, the true correlation of 0.7, the attention weights of 0.6 and the target attention weights of 0.65, the transformer training module 228 may compute the correlation alignment loss as 0.0004, the attention alignment loss as 0.0025, the regularization loss function as 0.001, and a final loss function as 0.0039. Once the final loss function is computed, the transformer training module 228 may tune/retrain the transformer model 208A over multiple epochs to minimize the final loss function, thereby generating the trained transformer model 208B. Usage of the loss functions for generating the trained transformer model 208B may enhance:
(i) accuracy by directly aligning the predicted correlation feature vectors with the ground-truth correlation feature vectors, ensuring precise correlation modeling.
(ii) interpretability by aligning the attention weights with the meaningful cross-domain interactions, enabling decisions of the trained transformer model 208B more transparent.
(iii) robustness by performing regularization to overfitting, which further enhance generalization of the trained transformer model 208B to untrained datasets.
(iv) insights by incorporating attention alignment. With the attention alignment, the trained transformer model 208B may not only predicts the correlations between the multi-modal datasets but also highlights which domain interactions are most influential.

At step 510, the method 500 includes storing the trained transformer model 208B in the model database 202.

At step 512, the method 500 includes utilizing the trained transformer model 208B to determine and store the correlations 254 between the multi-modal datasets 250 in the internal database 204. Determining the correlations 254 utilizing the trained transformer model 208B is described in detail in FIG. 6.

As depicted in FIG. 6, the trained transformer model 208B may include an input layer 208B-1, an encoder layer 208B-2, and an output layer 208B-3. The encoder layer 208B-2 may utilize the multi-head self-attention mechanism. Accordingly, the encoder layer 208B-2 may include a positional encoding layer 208B-2A, self-attention layers 208B-2B with multiple heads (e.g., 8 heads), feedforward layers 208B-2C, and add and normalization layers 208B-2D. In some examples, the encoder layer 208B-2 may include a ‘m’ number of layers (e.g., 6) and a ‘n’ number of heads (e.g., 8). The feedforward layers 208B-2C may include a fully connected feed-forward network with a hidden size of 256. The output layer 208B-3 may include a linear layer 208B-3A.

The validation datasets 252B may be provided to the input layer 208B-1. The latent vectors 252 may include numerical representations of words/tokens present in the multi-modal datasets 250. The input layer 208B-1 may forward the validation datasets 252B to the positional encoding layer 208B-2A of the encoder layer 208B-2. The positional encoding layer 208B-2A may incorporate positional information to the received validation datasets, thereby an order of words may be preserved. The validation datasets 252B incorporated with the positional information may be provided to the self-attention layers 208B-2B. Each head in the self-attention layers 208B-2B may capture different features, relationships, and dependencies for each word/token in the validation datasets 252B. Therefore, the trained transformer model 208B may be enabled to interpret various parts of the validation datasets 252B at the same time, effectively capturing both short-term and long-term dependencies between the validation datasets 252B. The captured different features, relationships, and dependencies for each word/token in the validation datasets 252B by the heads of the self-attention layers 208B-2B may be forwarded to the respective feedforward layers 208B-2C. The feedforward layers 208B-2C may apply the fully connected feed-forward network to process and combine the captured different features, relationships, and dependencies for each word/token in the validation datasets 252B while maintaining a respective position of each word/token. The add and normalization layers 208B-2D may apply layer normalization on outputs of the self-attention layers 208B-2A and outputs of the feedforward layers 208B-2C and combine inputs and outputs of each of the self-attention layers 208B-2A and the feedforward layers 208B-2C, thereby generating a concatenated output. Using the liner layer 208B-3A, the output layer 208B-3 may linearly transform the concatenated output to feature vectors. The feature vectors may represent the correlations 254 between the validation datasets 252B (e.g., the multi-modal datasets 250).

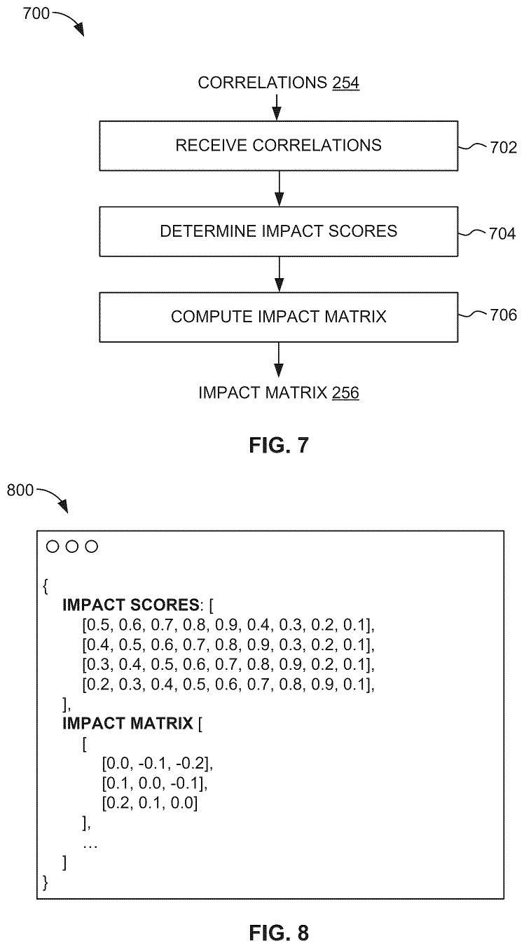

FIG. 7 is an exemplary flow diagram presenting a method 700 for computing the impact matrix 256 for the multi-modal datasets 250, in accordance with implementations of the present disclosure. In some implementations, the method 700 may be executed by the processor 110 of the system 102 using the strategy generation engine 124, as described in relation to FIGS. 1 and 2.

At step 702, the method 700 includes receiving the correlations 254 between the multi-modal datasets 250 (e.g., the feature vectors determined using the trained transformer model 208B).

At step 704, the method 700 includes determining impact scores. The set of decision-making strategies 260 may be identified based on the correlations 254 between the multi-modal datasets 250 and impact metrics may be identified for each pair of decision-making strategies in the set of decision-making strategies 260. Based on the impact metrics identified for each pair of the decision-making strategies, the impact scores may be determined for each decision-making strategy in the set of decision-making strategies 260.

For example, consider a scenario where that the multi-modal datasets 250 include financial reports from financial operations and security incidents from security operations. In such an example, the correlations 254 may include correlations between the financial reports and the security incidents. Based on such correlations, the set of decision-making strategies 260 may be identified for the financial reports and the security incidents. By way of non-limiting example, the set of decision-making strategies 260 may include: a first financial operation strategy (e.g., low budget allocation strategy), a second financial operation strategy (e.g., a medium budget allocation strategy), a third financial operation strategy (e.g., a high budget allocation strategy), a first security operation strategy (e.g., a basic security measure based strategy), a second security operation strategy (e.g., an intermediate security measures based strategy), and a third security operation strategy (e.g., an advanced security measures based strategy). The first, second, and third financial operation strategies may be for reducing budget allocation by minimizing financial resources being allocated towards the financial operations, while maintaining essential services and cost-cutting measures. The first, second, and third financial operation strategies may include allocating low budget, medium budget, and high budget, respectively for the financial operations. The first security operation strategy may include minimal security protocols/measures, basic threat detection, and response measures. The first security operation strategy may be identified for addressing the risky security threats without significant resource investment. The second security operation strategy may include a balanced approach with moderate resource allocation towards the security operations. For example, the second security operation strategy may include a combination of preventive measures, regular monitoring, and more advanced threat detection compared to the first security operation strategy. The third security operation strategy may include significant investment for the security operations. For example, the third security operation strategy may include a combination of threat detection, continuous monitoring, proactive incident responses, and advanced security technologies.

Further, the impact scores may be determined based on the impact metrics identified for each of the first, second, and third financial operation strategies with respect to each of the first, second, and third security operation strategies. An impact score may indicate a correlation between a respective pair of decision-making strategies, describing how the respective pair of decision-making strategies work together. If the impact score is high (close to ‘1’ (e.g., above 0.5)), there exists a high correlation and positive impact between the respective pair of decision-making strategies. If the impact sore is low (close to ‘0’ (e.g., below 0.5)), there exists a moderate correlation and little to no impact between the respective pair of decision-making strategies. If the impact score is negative (close to ‘−1’), there exists a low correlation and negative between the respective pair of decision-making strategies. Exemplary impact scores determined for each of the first, second, and third financial operation strategies with respect to each of the first, second, and third security operation strategies are described below:
(i) Impact scores determined for the first financial operation strategy with respect to the first, second, and third security operation strategies, respectively:

0.5: If the first financial operation strategy includes allocating the low budget and the first security operation strategy including the low security measures, then the impact score may be 0.6 that indicates a moderate correlation between the first financial operation strategy and the first security operation strategy. When the first financial operation strategy is implemented, the first security operation strategy may tend to perform moderately together with the first financial operation strategy.

0.6: If the first financial operation strategy includes allocating the low budget and the second security operation strategy including the medium security measures, then the impact score may indicate a correlation between the first financial operation strategy and the second security operation strategy as 0.6.

0.7: If the first financial operation strategy includes allocating the low budget and the third security operation strategy including the advanced security measures, then the impact score may indicate a correlation between the first financial operation strategy and the third security operation strategy as 0.6.

(ii) Impact scores determined for the second financial operation strategy with respect to the first, second, and third security operation strategies:

0.8: Correlation of the second financial operation strategy with the first security operation strategy.

0.9: Correlation of the second financial operation strategy with the second security operation strategy.

0.4: Correlation of the second financial operation strategy with the third security operation strategy.

(iii) Impact scores determined for the third financial operation strategy with respect to the first, second, and third security operation strategies:

0.3: Correlation of the third financial operation strategy with the first security operation strategy.

0.2: Correlation of the third financial operation strategy with the second security operation strategy.

0.1: Correlation of the third financial operation strategy with the third security operation strategy.

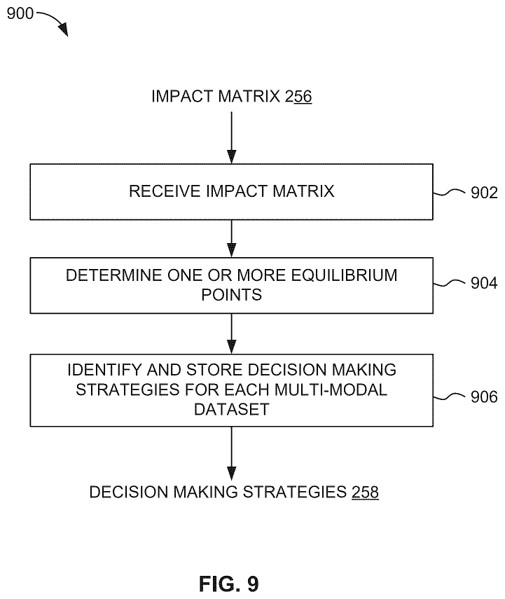

At step 706, the method 700 includes computing the impact matrix 256 based on the impact scores. The impact matrix 256 may be stored in the internal database 204. An exemplary illustration 800 including the impact scores and the impact matrix is depicted in FIG. 8.

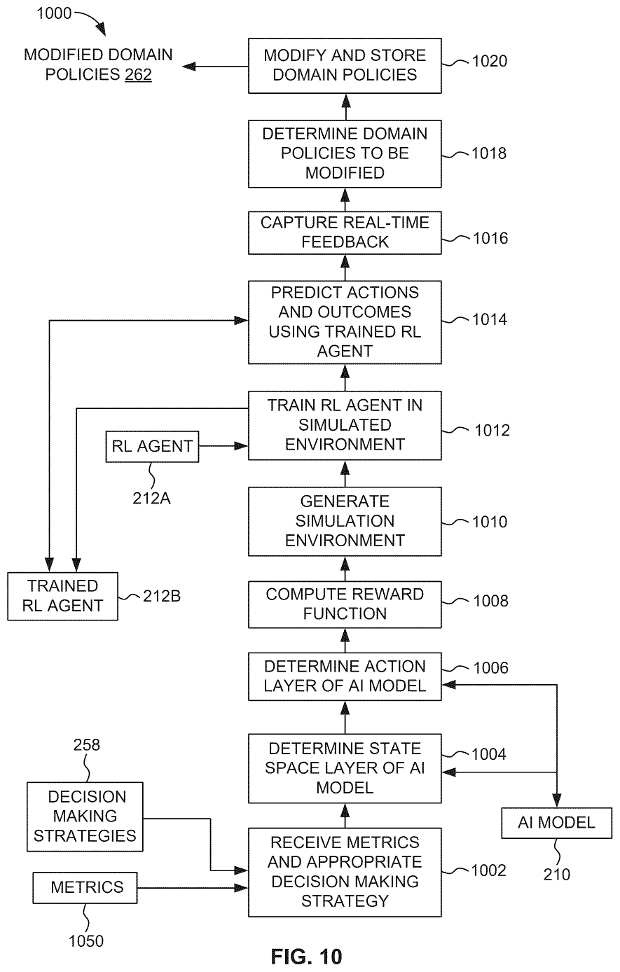

FIG. 9 is an exemplary flow diagram presenting a method 900 for generating the one or more decision-making strategies 258 for each of the multi-modal datasets 250 using the impact matrix 256, in accordance with implementations of the present disclosure. In some implementations, the method 700 may be executed by the processor 110 of the system 102 using the strategy generation engine 124, as described in relation to FIGS. 1 and 2.

At step 902, the method 900 includes receiving the impact matrix 256. At step 904, the method 900 includes determining the one or more equilibrium points by solving the impact matrix 256. The one or more equilibrium points may indicate that the impact scores may not be changed even changing any pair of decision-making strategies. For example, consider that the set of decision-making strategies identified for the multi-modal datasets may include first, second, and third financial operation strategies, and first, second, and third security operation strategies. The first, second, and third financial operation strategies may include allocating 20%, 25%, and 30% of budget to security operations, respectively. The first, second, and third security operation strategies may include basic, intermediate, and advanced security measures, respectively. In such a scenario, the one or more equilibrium points may be determined at the second financial operation strategy including allocating 25% of budget for the security operations with the second security operation strategy including the intermediate security measures. Therefore, the one or more equilibrium points may indicate that the second financial operation strategy and the second security operation strategy are balanced, where the impact scores may not be changed even by changing the respective second financial operation strategy and the second security operation strategy.

At step 906, the method 900 includes identifying and storing the one or more decision-making strategies 258 for each of the multi-modal datasets 250 based on the one or more equilibrium points. For example, consider that the one or more equilibrium points are determined at the second financial operation strategy including allocating 25% of budget for the security operations with the second security operation strategy including the intermediate security measures. In such an example, a decision-making strategy for the multi-modal dataset including financial reports may be identified as allocating 25% of budget for the security operations and a decision-making strategy for the multi-modal dataset including the security incidents may include the intermediate security measures.

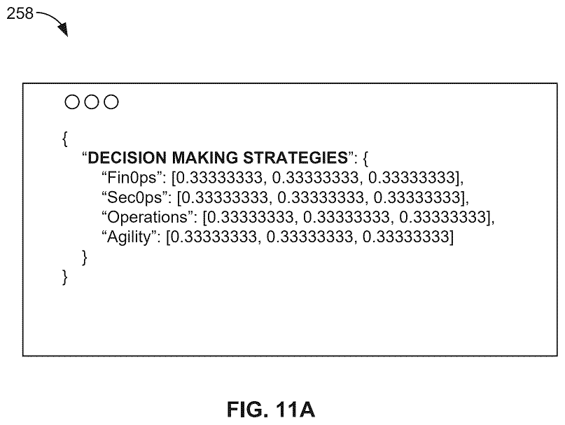

FIG. 10 is an exemplary flow diagram presenting a method 1000 for generating the modified one or more domain policies 262 for the multi-modal datasets 250, in accordance with implementations of the present disclosure. In some implementations, the method 1000 may be executed by the processor 110 of the system 102 using the policy optimization engine 126, as described in relation to FIGS. 1 and 2.

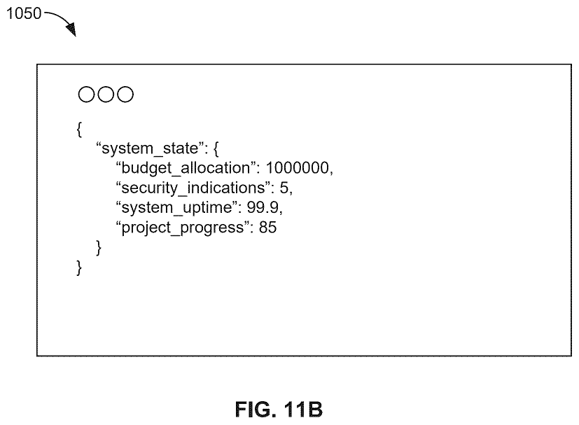

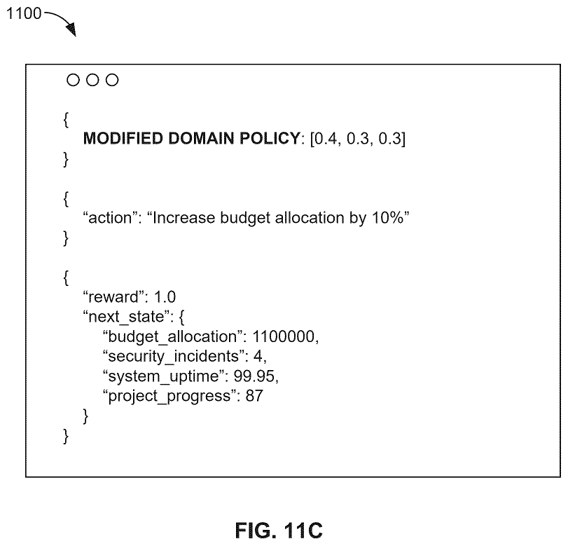

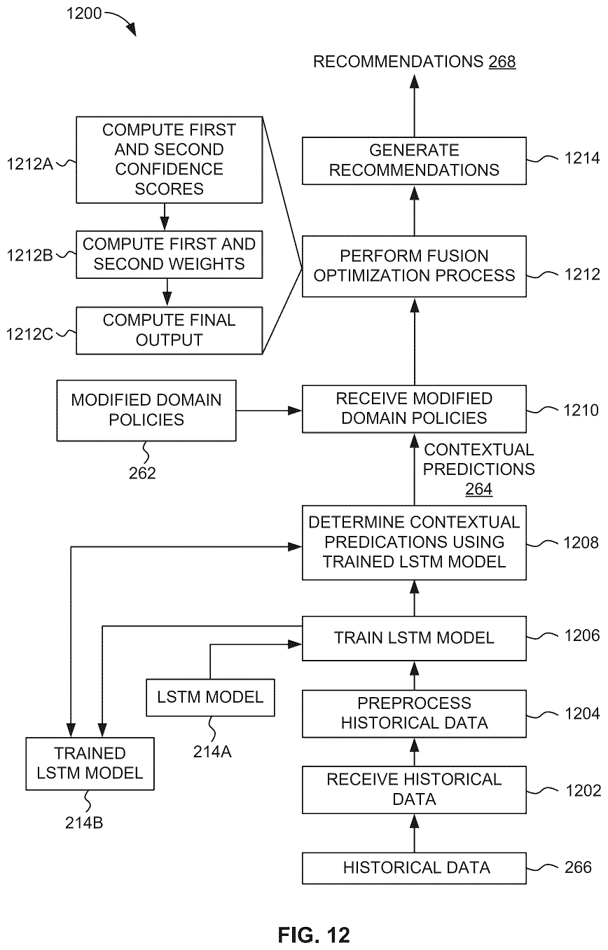

At step 1002, the method 1000 includes receiving the one or more decision-making strategies 258 determined for the multi-modal datasets 250 and metrics 1050 representing a current state of the real-world enterprise environment. Exemplary one or more decision-making strategies 258 determined for the multi-modal datasets 250 is depicted in FIG. 11A. Non-limiting examples of the metrics 1050 may include budget allocation, system uptime, a number of security incidents, project progress, and/or the like. The budget allocation may indicate percentages of budgets or costs allocated for the domains/functions such as security operations, technical operations, and/or the like. The system uptime may include parameters identifying monitoring of servers being hosted by the enterprises. The number of security incidents may include incident counts from security dashboards. The project progress may include a status of each of key projects impacting availability of computational resources. Exemplary metrics 1050 representing the current state of the real-world enterprise environment is depicted in FIG. 11B.

At step 1004, the method 1000 includes determining a state space layer of the AI model 210 based on the metrics 1050. At step 1006, the method 1000 includes determining an action space layer of the AI model 210 based on the one or more decision-making strategies 258 determined for the multi-modal datasets 250. The action space layer of the AI model 210 may include predicted actions based on the one or more decision-making strategies 258. Non-limiting examples of the predicted actions may include adjusting budget allocations, implementing security measures, modifying project timelines, and/or the like. At step 1008, the method 1000 includes computing a reward function. The reward function may indicate feedback on the predicted actions. By way of non-limiting example, a positive reward function may be computed for the predicted actions that improve the system uptime and a negative reward function (e.g., penalty) may be computed for the predicted actions that increase costs or project delays.

Upon determining the state space and action space layers of the AI model 210 and computing the reward function, at step 1010, the method 1000 includes generating a simulation environment of the enterprise emulating a real-world environment of the enterprise using real-world constraints and dynamics. The simulation environment may be generated based on the determined state space layer and action space layer, and the computed reward function.

At step 1012, the method 1000 includes training the RL agent 212A in the simulated environment of the enterprise, thereby generating the trained RL agent 212B. In some examples, the training methods such as deep Q-learning, actor-critic methods, and/or the like, may be used to train the RL agent 212A in the simulated environment. The simulated environment may be used to generate the training episodes where the RL agent 212A may be enabled to learn interacting with the simulated environment, while predicting the actions and the outcomes associated with the actions and receiving the reward function for each of the predicted outcomes corresponding to the respective actions. From training of the RL agent 212A in the simulated environment, training datasets may be generated. The training datasets may indicate the reward functions computed for the predicted actions and a next state of the IT environment of the enterprise. The reward functions and the next state (e.g., state transition from the current state to the next state) may be used to tune/retrain the RL agent 212A over the training episodes. Therefore, the trained RL agent 212B may be generated that may learn and update the one or more domain policies based on the reward functions and the next state and improve the decision-making strategies over time.

Once the trained RL agent 212B is generated, at step 1014, the method 1000 includes predicting actions and respective outcomes using the trained RL agent 212B. The trained RL agent 212B may be executed on the real-world enterprise environment, where the trained RL agent 212B may predict the actions and the respective outcomes based on the metrics 1050 associated with the real-world enterprise environment. Further, at step 1016, the method 1000 includes capturing real-time feedback and performance metrics on results of the execution of the trained RL agent 212B in the real-world enterprise environment. At step 1018, the method 1000 includes determining the one or more domain policies to be modified based on the predicted actions and the respective outcomes and reward functions, the captured real-time feedback and performance metrics. At step 1020, the method 1000 includes modifying and storing the determined one or more policies in the internal database 204, thereby generating the modified one or more domain policies 262 for the multi-modal datasets 250. For example, if an outcome of an exemplary action identifies a drop in the system uptime, the one or more domain policies associated with the financial operations may be modified to allocate more resources to the technical operations. For another example, if an outcome of another exemplary action identifies increased number of security incidents, the one or more domain policies associated with the security operations may be modified. Therefore, the modified one or more domain policies may include optimized domain policies enabling dynamic adjustments to budget allocations, security measures, and project timelines based on the real-time feedback and continuous learning. An exemplary illustration 1100 including an exemplary domain policy modified based on an action and a reward function is depicted in FIG. 11C.

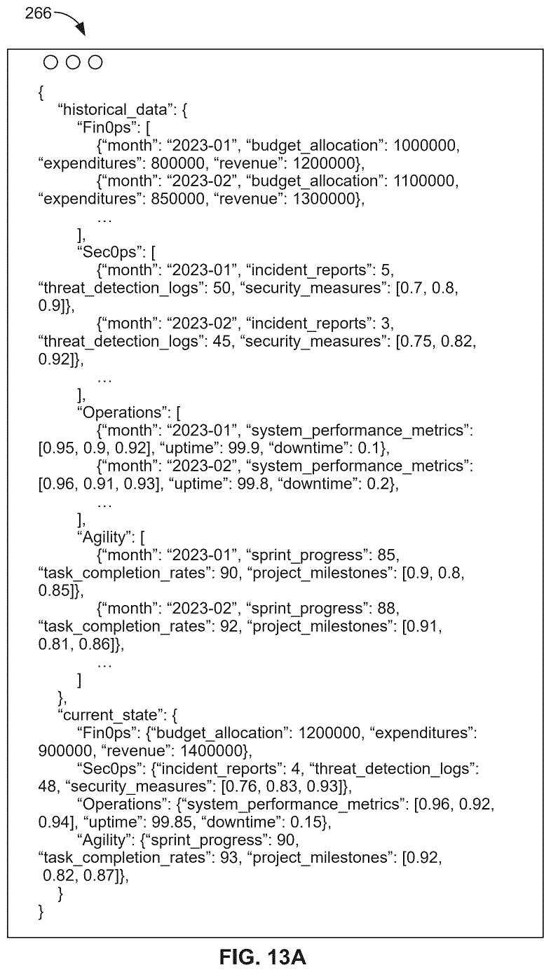

FIG. 12 is an exemplary flow diagram that presents a method 1200 for generating the recommendations 268 for performing the one or more actions, in accordance with implementations of the present disclosure. In some implementations, the method 1200 may be executed by the processor 110 of the system 102 using the policy optimization engine 126, as described in relation to FIGS. 1 and 2.

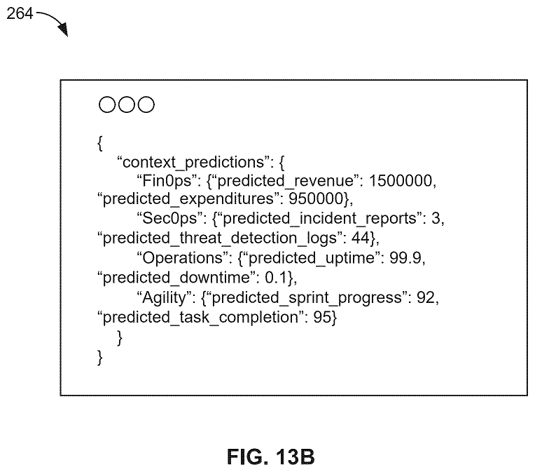

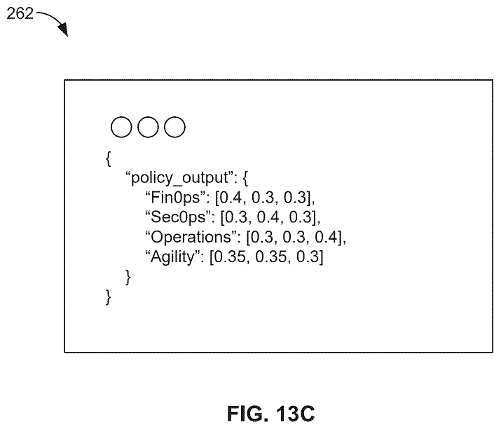

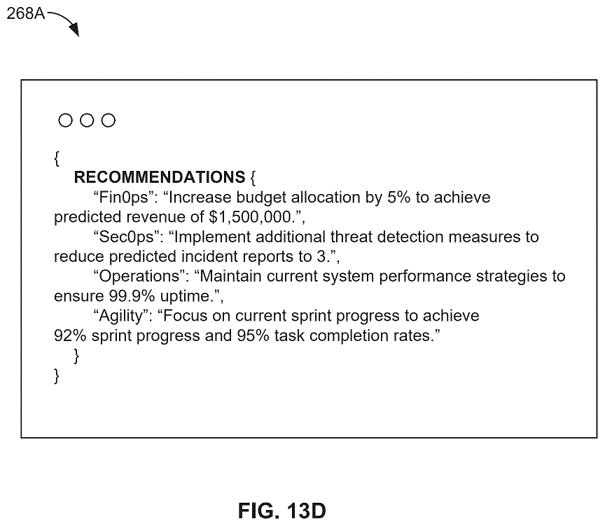

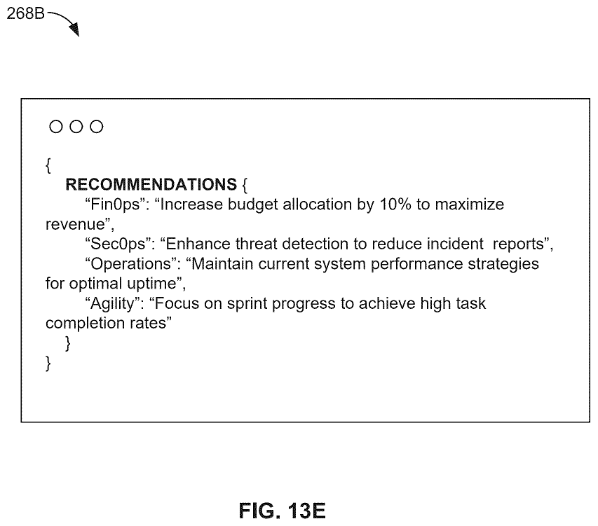

At step 1202, the method 1200 includes receiving the historical data 266. In some examples, the historical data 266 may be received from the internal database 204. The historical data may include past financial allocations, past system performance metrics, past security incidents, past project management data, and/or the like. Exemplary historical data 266 received from the internal database 204 is depicted in FIG. 13A. At step 1204, the method 1200 includes preprocessing the historical data 266 to generate time series data. The time series data may include structured sequences of data that is suitable for further time series analysis. At step 1206, the method 1200 includes training the LSTM model 214A based on the generated time series data, thereby generating the trained LSTM model 214B.

At step 1208, the method 1200 includes determining the contextual predictions 264 using the trained LSTM model 214B. In some examples, the metrics 1050 representing the real-world enterprise environment and the historical data 266 may be provided to the trained LSTM model 214B and enable the trained LSTM model 214B to determine the contextual predictions 264. The contextual predictions may include temporal patterns, anomalies, and forecasted values for the obtained historical data 266. Exemplary contextual predictions 264 determined using the trained LSTM model 214B is depicted in FIG. 13B.

At step 1210, the method 1200 includes receiving the modified one or more domain policies 262 using the trained RL agent 212B. An exemplary modified domain policy 262 using the trained RL agent 212B is depicted in FIG. 13C.

At step 1212, the method 1200 includes performing fusion optimization process. The fusion optimization process may involve integrating the contextual predictions 264 determined using the trained LSTM model 214B with the modified one or more domain policies 262 using the trained RL agent 212B for analysis. In some examples, from the integration, the contextual predictions 264 may be used for adjusting the one or more domain policies, ensuring that long-term trends and potential anomalies are considered for generating the recommendations.

In some examples, for performing the fusion optimization process, at step 1212A, the method 1200 includes computing the first confidence score and the second confidence score for the modified one or more domain policies 262 (using the trained RL agent 212B) and the contextual predictions 264 (determined using the trained LSTM model 214B). The first confidence score and the second confidence score may be computed based on one or more of; confidence, accuracy, and latest performance of the respective model/agent. For example, the first confidence score may be determined based on reward consistency, stability of the one or more domain policies determined using the trained RL agent 212B. For another example, the second confidence score may be determined based on prediction accuracy, error margins, and consistency/variance of historical data trends of the trained LSTM model 214B.

At step 1212B, the method 1200 includes computing the first weight and the second weight for the modified one or more domain policies 262 (using the trained RL agent 212B) and the contextual predictions 264 (determined using the trained LSTM model 214B). In some examples, the first weight and the second weight may be determined based on the first confidence score and the second confidence score, respectively. For example, the first weight with higher weights may be assigned to the contextual predictions 264 compared to the modified one or more domain policies 262, if the accuracy of the trained LSTM model 214B is higher compared to the trained RL agent 212B or vice-versa.

At step 1212C, the method 1200 includes computing the final output based on the first and second confidence scores, and the first and second weights.

At step 1214, the method 1200 includes generating the recommendations 268 based on the final output computed from the fusion optimization process. The recommendations 268 generated based on the final output may include comprehensive, contextually relevant, and optimized recommendations that integrate short-term policy decisions (derived from the modified one or more domain policies 262 using the trained RL agent 212B) with long-term predictions (derived from the contextual predictions 264 determined using the trained LSTM model 214B). For example, consider that the modified one or more domain policies 262 indicate recommendation of 25% budget allocation to security operations and the contextual predictions 264 predict an upcoming increase in security incidents. In such a scenario, integration of the modified one or more domain policies 262 and the contextual predictions 264 may enable adjusting of the recommendation to increase budget allocation to the security operations. Further, generating the recommendations 268 according to the present disclosure may (i) increase system uptime by dynamically allocating the computation resources to prioritize the operational stability, (ii) enhance security by proactively increasing security measures/resources during threat alerts and mitigating risks, and (iii) increase cost efficiency by continuously adjusting or modifying the one or more domain policies for dynamic allocation of the computational resources, adapting to real-world changes in the enterprise environment and aligning with goals of the enterprise for system uptime, security and cost efficiency.

By way of non-limiting example, consider that a modified domain policy of the modified one or more domain policies 262 indicates 25% of budget allocation to the security operations and the contextual predictions 264 indicate 30% of budget allocation to the security operations. Further, the modified domain policy may have the first confidence score of 0.8 (high confidence due to recent consistent performance of the trained RL agent 212B) and the first weight of 0.57. The contextual predictions 264 may have the second confidence score of 0.6 (moderate confidence based on historical accuracy of the trained LSTM model 214B) and the second weight of 0.43. In such a scenario, the recommendation 268 may be generated based on the final output computed based on the first and second confidence scores of 0.8 and 0.6, respectively, and the first and second weights of 0.57 and 0.43, respectively. In an example herein, the recommendation may indicate 26.85% of budget allocation to the security operations. Exemplary recommendations 268A and 268B are depicted in FIGS. 13D and 13E.

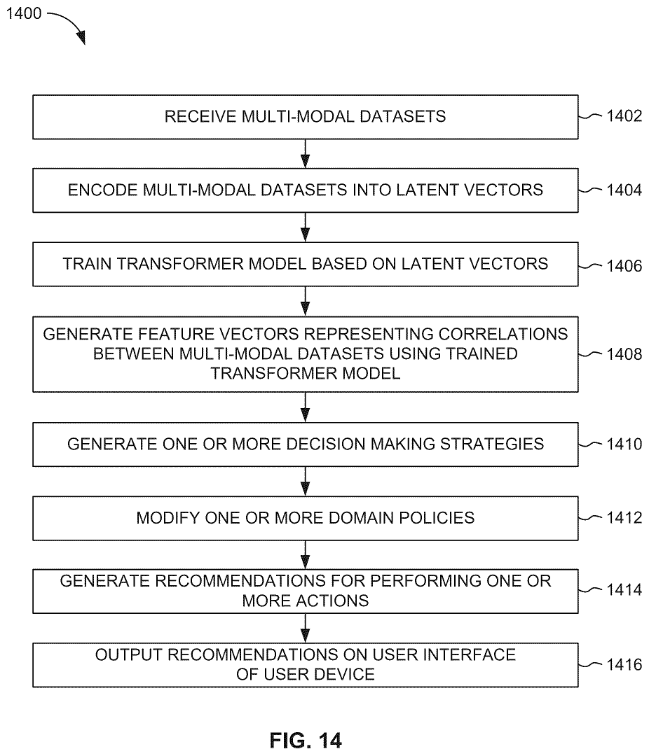

FIG. 14 is flow diagram that presents a method 1400 for generating the recommendations 268 for performing the one or more actions, in accordance with implementations of the present disclosure. In some implementations, the method 1400 may be executed by the processor 110 of the system 102 using the components 116-124 of the recommendation manager 114, as described in relation to FIGS. 1-13A-13D.

At step 1402, the method 1400 includes receiving the multi-modal datasets 250 from the data sources 104a-104n. The multi-modal datasets 250 include datasets from different domains corresponding to different functions within the enterprise. In some examples, the method 1400 may also include preprocessing the multi-modal datasets 250 by normalizing the multi-modal datasets 250 and converting the multi-modal datasets 250 into a specific data format.

At step 1404, the method 1400 includes encoding the multi-modal datasets 250 into the latent vectors 252 using the VQVAE model 206A. The latent vectors 252 may represent essential features of the multi-modal datasets 250. In some examples, for encoding the multi-modal datasets 250, the method 1400 includes generating the trained VQVAE model 206B by training the VQVAE model 206A based on the multi-modal datasets 250 (e.g., preprocessed multi-modal datasets), the reconstruction loss, and the commitment loss function. Once the trained VQVAE model 206B is generated, the method 1400 includes identifying the hierarchical features within the multi-modal datasets 250 by transforming the multi-modal datasets 250 into the continuous latent space using the multiple convolutional layers of the trained VQVAE model 206B. The method 1400 includes quantizing the hierarchical features to the nearest codebook vectors using the codebook parameters (that include the number of embeddings (K) and the dimensionality of each embedding vector (D). From the quantized nearest codebook vectors, the method 1400 includes generating the latent vectors 252 by reconstructing the multi-modal datasets 250 using the transposed convolutional layers of the trained VQVAE model 206B. Training of the VQVAE model 206A and using the trained VQVAE model 206B to encode the multi-modal datasets 250 into the latent vectors 252 are described in detail in conjunction with FIGS. 2, 3, and 4A-4B.

At step 1406, the method 1400 includes training the transformer model 208A based on the latent vectors 252 of the multi-modal datasets 250. In some examples, the method 1400 includes training the transformer model 208A with the latent vectors 252 to predict the correlation feature vectors from the latent vectors 252, and determining the ground truth correlation feature vectors obtained from the statistical measures, the attention weights of the transformer model 208A, and the target attention weights based on domain-specific insights and predefined attention patterns. Based on determined at least one of the predicted correlation feature vectors, the ground truth correlation feature vectors obtained from the statistical measures, the attention weights from the trained transformer model, and the target attention weights based on the domain-specific insights and the predefined attention patterns, the method 1400 includes computing the loss functions such as a correlation alignment loss function, an attention alignment loss function, and a regularization loss function. Based on the computed loss functions, the method 1400 includes determining the set of model parameters for meeting the minimum loss function and tuning the transformer model 208A based on the determined set of model parameters. Therefore, the trained transformer model 208B is generated to predict the correlations 254 between the multi-modal datasets 250.

At step 1408, the method 1400 includes generating feature vectors using the trained transformer model 208B. The feature vectors represent the correlations 254 between the multi-modal datasets 250. In some examples, for generating the feature vectors, the method 1400 includes determining the dependencies and relationships between each of the multi-modal datasets 250 using the trained transformer model 208B and generate the feature vectors by processing the dependencies and relationships between each of the multi-modal datasets 250 using the trained transformer model 208B. The feature vectors indicate the correlations 254 between the multi-modal datasets 250. Training of the transformer model 208A and using the trained transformer model 208B to generate the feature vectors are described in detail in conjunction with FIGS. 2, 5, and 6.

At step 1410, the method 1400 includes generating the one or more decision-making strategies 258 for each of the multi-modal datasets 250 based on the generated feature vectors using the trained transformer model 208B. In some examples, for generating the one or more decision-making strategies 258, the method 1400 includes computing the impact matrix 256 for the multimodal datasets 250 based on the feature vectors/correlations 254 generated using the trained transformer model 208B. Computing the impact matrix 256 is described in detail in conjunction with FIGS. 2, 7, and 8. Based on the computed impact matrix 256, the method 1400 includes determining the one or more equilibrium points for the set of decision-making strategies 260. Based on the one or more equilibrium points, the method 1400 includes identifying an appropriate decision-making strategy among the set of decision-making strategies 260 and generating the one or more decision-making strategies 260 for each of the multi-modal datasets 250 based on the appropriate decision-making strategy. The appropriate decision-making strategy may correspond to one of the one or more equilibrium points. Generating the one or more decision-making strategies 258 is described in detail in conjunction with FIGS. 2 and 9.

At step 1412, the method 1400 includes modifying the one or more domain policies associated with the enterprise based on the generated one or more decision-making strategies 258 and real-time feedback using the AI model 210. In some examples, for modifying the one or more domain policies, the method 1400 includes determining the state space layer and the action space layer of the AI model based on the generated one or more decision-making strategies 258. The state space layer includes the metrics 1050 representing the current state of the real-world enterprise environment such as a budget allocation, a system performance, security incidents, and project progress. The action space layer of the AI model includes predicted actions. Based on the determined action space layer and the state space layer, the method 1400 includes computing the reward function indicating the feedback on outcomes of the predicted actions. Based on the determined action space layer, the state space layer, and the reward function, the method 1400 includes generating the simulation environment of the enterprise emulating the real-world enterprise environment using real-world constraints and dynamics. Once the simulation environment is generated, the method 1400 includes training the RL agent 212A with the computed reward function, and the determined action space layer and state space layer in the simulated environment. Therefore, the trained RL agent 212B may be generated. The method 1400 includes generating the training datasets corresponding to the one or more decision-making strategies 258 by simulating the trained RL agent 212B in the real-world enterprise environment. Based on the generated training datasets, the method 1400 includes predicts actions and outcomes for each of the actions. Based on the predicted actions and the corresponding outcomes, the method 1400 includes determining the one or more domain policies to be modified and modifying the determined one or more domain policies. Therefore, generating the modified one or more domain policies 262. In some examples, the method 1400 includes capturing the real-time feedback and performance metrics associated with the real-world enterprise environment and periodically updating the one or more domain policies based on the captured real-time feedback and the performance metrics. Modifying the one or more domain policies is described in detail in conjunction with FIGS. 2, 10, and 11A-11C.

At step 1414, the method 1400 includes generating the recommendations 268 for performing one or more actions corresponding to the multi-modal datasets 250 based on the modified one or more domain policies 262 and the historical data 266. In some examples, for generating the recommendations 268, the method 1400 includes obtaining the historical data 266 corresponding to the enterprise from the data sources 104a-104n, generating the time series data for the obtained historical data by preprocessing the obtained historical data 266, and predicting the temporal patterns, the anomalies, and the forecasted values (the contextual predictions 264) for the obtained historical data 266 by training the LSTM model 214A with the generated time-series data. Further, the method 1400 includes computing the first confidence score for the modified one or more domain policies 262 using the trained RL agent 212B and the second confidence score for the predicted temporal patterns, the anomalies, and the forecasted values using the trained LSTM model 214B. The method 1400 includes computing the first weight for the modified one or more domain policies 262 and the second weight for the predicted temporal patterns, the anomalies, and the forecasted values based on the first and second confidence scores. Based on the first and second confidence scores, and the first and second RL weights, the method 1400 includes computing the final output. Based on the final output, the method 1400 includes generating the recommendations 268 for performing the one or more actions. Generating the recommendations 268 is described in detail in conjunction with FIGS. 2, 12, and 13A-13E.

At step 1416, the method 1400 includes outputting the recommendations 268 for performing the one or more actions on the user interface of the user device 106.

Implementations of the present disclosure provide technical solutions to multiple technical problems that arise in the context of managing real-world enterprise environment that uses computing resources provided by multiple cloud computing platforms. Implementations of the present disclosure provide a robust and adaptive framework for generating the recommendations that are used to perform the one or more actions/cloud management actions for managing the real-world enterprise environment by ensuring dynamic, context-aware, and optimized decision-making strategies.

Implementations of the present disclosure involve a comprehensive and efficient approach from collecting the multi-modal datasets from the different domains to generating the comprehensive and contextually enriched recommendations by correlating and optimizing the multi-modal datasets using the various AI models such as the VQVAE model, the transformer model, the AI model, the RL agent, and the LSTM model. The various AI models may be with reduced size and complexity. Therefore, the recommendations may be generated with the minimal utilization of the computational resources, which may further reduce cost and time required for generating the recommendations.

To illustrate in detail, implementations of the present disclosure enable generation of the recommendations with the following advantages:
(i) Optimized model execution and cost reduction: Usage of the various AI models with reduced size and complexity may enable faster inference with low requirements of the computational resources. By leveraging advanced compression techniques and optimized inference paths, the various AI models may be operated effectively on the computational resources with low specifications such as Graphical Processing Units (GPUs) with low memory and low compute power, which may further save the cost specifically in scaled environments by reducing computational load while maintaining high performance.
(ii) Scalability: Leveraging the advanced compression techniques and the optimized inference paths for operating the various AI models may enable efficient utilization of the computational resources, allowing the system to scale up without proportionally increasing costs or computational demands.
(iii) Parallel processing: training and inferences of the various AI models may be performed by leveraging parallel computation, which may enhance throughput and reduce latency.

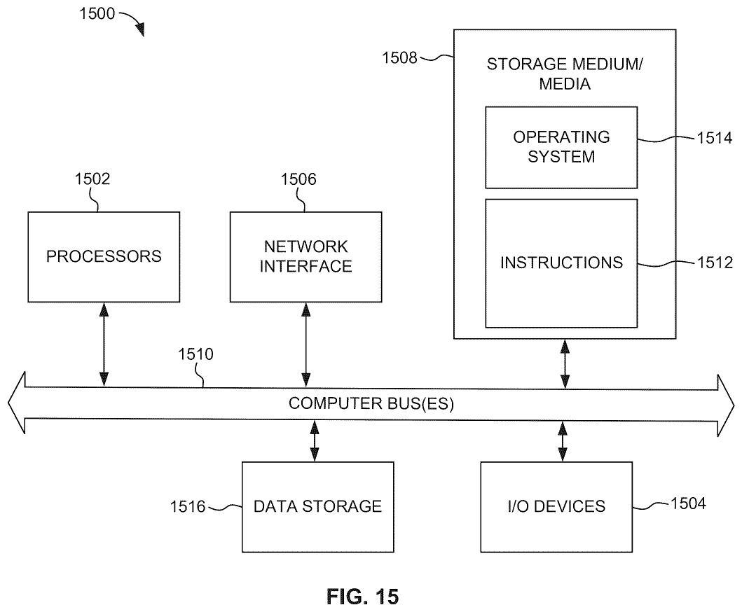

FIG. 15 depicts a computer system 1500 that may be used to implement the method 1400. More particularly, computing machines such as desktops, laptops, smartphones, tablets, and wearables which may be used for generating the recommendations for performing the one or more actions to manage the real-world enterprise environment. The computer system 1500 may include additional components not shown and that some of the process components described may be removed and/or modified. In another example, the computer system 1500 may be deployed on external-cloud platforms such as cloud, internal corporate cloud computing clusters, organizational computing resources, and/or the like.

The computer system 1500 includes processor(s) 1502, such as a central processing unit, ASIC or another type of processing circuit, input/output devices 1504, such as a display, mouse keyboard, and/or the like, a network interface 1506, such as a Local Area Network (LAN), a wireless 802.11x LAN, a 3G or 4G mobile WAN or a WiMax WAN, and a computer-readable medium 1508. Each of these components may be operatively coupled to a bus 1510. The computer-readable medium 1508 may be any suitable medium that participates in providing instructions to the processor(s) 1502 for execution. For example, the computer-readable medium 1508 may be non-transitory or non-volatile medium, such as a magnetic disk or solid-state non-volatile memory or volatile medium such as RAM. The instructions or modules stored on the computer-readable medium 1508 may include machine-readable instructions 1512 executed by the processor(s) 1502 that cause the processor(s) 1502 to perform the method 1400.

The computing system 1500 may be implemented as software stored on a non-transitory processor-readable medium and executed by the processor(s) 1502. For example, the computer-readable medium 1508 may store an operating system 1514, such as MAC OS, MS WINDOWS, UNIX, or LINUX, and code, for the computing system 1500. The operating system 1514 may be multi-user, multiprocessing, multitasking, multithreading, real-time, and the like. For example, during runtime, the operating system 1514 is running and the code for the computing system 1500 is executed by the processor(s) 1502.

The computer system 1500 may include a data storage 1516, which may include non-volatile data storage. The data storage 1516 stores any data used or generated by the computer system 1500.

The network interface 1506 connects the computer system 1500 to internal systems for example, via a LAN. Also, the network interface 1506 may connect the computer system 1500 to the Internet. For example, the computer system 1500 may connect to web browsers and other external applications and systems via the network interface 1506.

What has been described and illustrated herein is an example along with some of its variations. The terms, descriptions, and figures used herein are set forth by way of illustration only and are not meant as limitations. Many variations are possible within the scope of the subject matter, which is intended to be defined by the following claims and their equivalents.

Implementations and all of the functional operations described in this specification may be realized in digital electronic circuitry, or in computer software, firmware, or hardware, including the structures disclosed in this specification and their structural equivalents, or in combinations of one or more of them. Implementations may be realized as one or more computer program products (i.e., one or more modules of computer program instructions encoded on a computer readable medium for execution by, or to control the operation of, data processing apparatus). The computer readable medium may be a machine-readable storage device, a machine-readable storage substrate, a memory device, a composition of matter effecting a machine-readable propagated signal, or a combination of one or more of them. The term “computing system” encompasses all apparatus, devices, and machines for processing data, including by way of example a programmable processor, a computer, or multiple processors or computers. The apparatus may include, in addition to hardware, code that creates an execution environment for the computer program in question (e.g., code that constitutes processor firmware, a protocol stack, a database management system, an operating system, or any appropriate combination of one or more thereof). A propagated signal is an artificially generated signal (e.g., a machine-generated electrical, optical, or electromagnetic signal) that is generated to encode information for transmission to suitable receiver apparatus.

A computer program (also known as a program, software, software application, script, or code) may be written in any appropriate form of programming language, including compiled or interpreted languages, and it may be deployed in any appropriate form, including as a stand-alone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry (e.g., an FPGA (field programmable gate array) or an ASIC (application specific integrated circuit)).

Processors suitable for the execution of a computer program include, by way of example, both general and special purpose microprocessors, and any one or more processors of any appropriate kind of digital computer. Generally, a processor will receive instructions and data from a read only memory or a random-access memory or both. Elements of a computer may include a processor for performing instructions and one or more memory devices for storing instructions and data. Generally, a computer will also include or be operatively coupled to receive data from or transfer data to, or both, one or more mass storage devices for storing data (e.g., magnetic, magneto optical disks, or optical disks). However, a computer need not have such devices. Moreover, a computer may be embedded in another device (e.g., a mobile telephone, a personal digital assistant (PDA), a mobile audio player, a Global Positioning System (GPS) receiver). Computer readable media suitable for storing computer program instructions and data include all forms of non-volatile memory, media and memory devices, including by way of example semiconductor memory devices (e.g., EPROM, EEPROM, and flash memory devices); magnetic disks (e.g., internal hard disks or removable disks); magneto optical disks; and CD ROM and DVD-ROM disks. The processor(s) 1502 and the memory may be supplemented by, or incorporated in, special purpose logic circuitry.

To provide for interaction with a user, implementations may be realized on a computer having a display device (e.g., a CRT (cathode ray tube), LCD (liquid crystal display) monitor) for displaying information to the user and a keyboard and a pointing device (e.g., a mouse, a trackball, a touch-pad), by which the user may provide input to the computer. Other kinds of devices may be used to provide for interaction with a user as well; for example, feedback provided to the user may be any appropriate form of sensory feedback (e.g., visual feedback, auditory feedback, tactile feedback); and input from the user may be received in any appropriate form, including acoustic, speech, or tactile input.

Implementations may be realized in a computing system that includes a back end component (e.g., as a data server), a middleware component (e.g., an application server), and/or a front end component (e.g., a client computer having a graphical user interface or a Web browser, through which a user may interact with an implementation), or any appropriate combination of one or more such back end, middleware, or front end components. The components of the system may be interconnected by any appropriate form or medium of digital data communication (e.g., a communication network). Examples of communication networks include a local area network (“LAN”) and a wide area network (“WAN”), e.g., the Internet.

The computing system may include clients and servers. A client and server are generally remote from each other and interact through a communication network. The relationship of client and server arises by virtue of computer programs running on the respective computers and having a client-server relationship to each other.

While this specification contains many specifics, these should not be construed as limitations on the scope of the disclosure or of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

A number of implementations have been described. Nevertheless, it will be understood that various modifications may be made without departing from the scope of the disclosure. For example, various forms of the flows shown above may be used, with steps re-ordered, added, or removed. Accordingly, other implementations are within the scope of the following claims.

What is claimed is:

1. A system comprising:
a processor; and
a memory communicably coupled to the processor, wherein the memory comprises processor-executable instructions which, when executed by the processor, cause the processor to:
receive a plurality of multi-modal datasets from a plurality of data sources, wherein the plurality of multi-modal datasets comprises datasets from a plurality of domains corresponding to a plurality of functions within an enterprise;
encode the received plurality of multi-modal datasets into a plurality of latent vectors using a Vector Quantized Variational Autoencoders (VQVAE) model, wherein the plurality of latent vectors represents essential features of the received plurality of multi-modal datasets;
train a transformer model based on the encoded plurality of latent vectors;
generate a plurality of feature vectors using the trained transformer model, wherein the plurality of feature vectors represents a plurality of correlations between the multi-modal datasets;
generate at least one decision-making strategy for each of the plurality of multi-modal datasets based on the generated plurality of feature vectors using the trained transformer model;
modify at least one domain policy associated with the enterprise based on the generated at least one decision-making strategy and real-time feedback using an Artificial Intelligence (AI) model;
generate a plurality of recommendations for performing at least one action corresponding to the plurality of multi-modal datasets based on the modified at least one domain policy, and historical data; and
output the generated plurality of recommendations for performing the at least one action on a user interface of a user device.

2. The system of claim 1, wherein the processor is further configured to:
preprocess the received plurality of multi-modal datasets by normalizing the received plurality of multi-modal datasets and converting the plurality of multi-modal datasets into a specific data format.

3. The system of claim 1, wherein to encode the received plurality of multi-modal datasets into the plurality of latent vectors using the VQVAE model, the processor is configured to:
train the VQVAE model with pre-processed plurality of multi-modal datasets using a reconstruction loss function and a commitment loss function;
identify a plurality of hierarchical features within the plurality of multi-modal datasets by transforming the plurality of multi-modal datasets into a continuous latent space using multiple convolutional layers of the trained VQVAE model;
quantize the identified plurality of hierarchical features to a nearest codebook vectors using codebook parameters, wherein the codebook parameters comprise a number of embeddings (K) and a dimensionality of each embedding vector (D); and
generate the plurality of latent vectors by reconstructing the plurality of multi-modal datasets from the quantized nearest codebook vectors using transposed convolutional layers of the trained VQVAE model.

4. The system of claim 1, wherein to train the transformer model based on the encoded plurality of latent vectors, the processor is configured to:
train the transformer model with the encoded plurality of latent vectors to predict correlation feature vectors from the encoded plurality of latent vectors;
determine ground truth correlation feature vectors obtained from statistical measures, attention weights of the transformer model, and target attention weights based on domain-specific insights and predefined attention patterns;
compute a plurality of loss functions based on determined at least one of the predicted correlation feature vectors, the ground truth correlation feature vectors obtained from the statistical measures, the attention weights from the trained transformer model, and the target attention weights based on the domain-specific insights and the predefined attention patterns, wherein the plurality of loss functions comprise at least one of a Correlation Alignment Loss function, an Attention Alignment Loss function, and a Regularization Loss function;
determine a set of model parameters for meeting a minimum loss function level based on the computed plurality of loss functions; and
tune the trained transformer model based on the determined set of model parameters to predict the plurality of correlations between the plurality of multi-modal datasets.

5. The system of claim 1, wherein to generate the plurality of feature vectors using the trained transformer model, the processor is configured to:
determine a plurality of dependencies and relationships between each of the plurality of multi-modal datasets using the trained transformer model; and
generate the plurality of feature vectors using the trained transformer model, and the determined plurality of dependencies and the correlations.

6. The system of claim 1, wherein to generate the at least one decision-making strategy for each of the plurality of multi-modal datasets based on the generated plurality of feature vectors using the trained transformer model, the processor is configured to:
compute an impact matrix for the plurality of multi-modal datasets based on the generated plurality of feature vectors using the trained transformer model;
determine at least one equilibrium point for a plurality of decision-making strategies based on the computed impact matrix;
identify an appropriate decision-making strategy among the plurality of decision-making strategies based on the determined at least one equilibrium point for each of the plurality of multi-modal datasets, wherein the appropriate decision-making strategy corresponds to the determined at least one equilibrium point; and
generate the at least one decision-making strategy for each of the plurality of multi-modal datasets based on the identified appropriate decision-making strategy.

7. The system of claim 1, wherein to modify the at least one domain policy associated with the enterprise based on the generated at least one decision-making strategy and real-time feedback using the AI model, the processor is configured to:
determine a state space layer of the AI model based on the generated at least one decision-making strategy, wherein the state space layer comprises a plurality of metrics comprising a budget allocation, a system performance, security incidents and project progress;
determine an action space layer of the AI model based on the generated at least one decision-making strategy, wherein the action space layer comprises predicted actions;
compute a reward function indicating feedback on outcomes of the predicted actions based on the determined action space layer and the state space layer;
generate a simulation environment of the enterprise emulating a real-world enterprise environment using real-world constraints and dynamics;
train a reinforcement learning (RL) agent with the computed reward function, the determined action space layer, and the state space layer in the generated simulation environment;
generate a plurality of training datasets corresponding to the generated at least one decision-making strategy by simulating the trained RL agent in the generated simulation environment;
predict a plurality of actions and a corresponding outcome associated with each of the plurality of actions based on the generated plurality of training datasets;
determine the at least one domain policy associated with the enterprise required to be modified based on the predicted plurality of actions and the corresponding outcome associated with each of the plurality of actions; and
modify the at least one domain policy associated with the enterprise based on the determination.

8. The system of claim 1, the processor is further configured to:
capture real-time feedback and performance metrics associated with real-world enterprise environment; and
periodically update the at least one domain policy based on the captured real-time feedback and the performance metrics.

9. The system of claim 1, wherein the processor is further configured to:
obtain historical data corresponding to the enterprise from the plurality of data sources;
generate a time-series data for the obtained historical data by preprocessing the obtained historical data; and
predict temporal patterns, a plurality of anomalies and forecasted values for the obtained historical data by training a Long Short-Term Memory (LSTM) model with the generated time-series data.

10. The system of claim 1, wherein to generate the plurality of recommendations for performing the at least one action corresponding to the plurality of multi-modal datasets based on the modified at least one domain policy, and the historical data, the processor is configured to:
compute a first confidence score for the modified at least one domain policy based on a performance of the trained RL agent;
compute a second confidence score for the predicted temporal patterns, the plurality of anomalies and the forecasted values based on prediction accuracy, error margins, and consistency of historical data trends of the trained LSTM model;
compute a first weight for the modified at least one domain policy based on the first confidence score, and the second confidence score;
compute a second weight for the predicted temporal patterns, the plurality of anomalies and the forecasted values based on the first confidence score and the second confidence score;
compute a final output based on the first confidence score, the second confidence score, the first weight, and the second weight; and
generate the plurality of recommendations for performing the at least one action based on the final output.

11. A method comprising:
receiving, by a processor, a plurality of multi-modal datasets from a plurality of data sources, wherein the plurality of multi-modal datasets comprises datasets from a plurality of domains corresponding to a plurality of functions within an enterprise;
encoding, by the processor, the received plurality of multi-modal datasets into a plurality of latent vectors using a Vector Quantized Variational Autoencoders (VQVAE) model, wherein the plurality of latent vectors represents essential features of the received plurality of multi-modal datasets;
training, by the processor, a transformer model based on the encoded plurality of latent vectors;
generating, by the processor, a plurality of feature vectors using the trained transformer model, wherein the plurality of feature vectors represents a plurality of correlations between the multi-modal datasets;
generating, by the processor, at least one decision-making strategy for each of the plurality of multi-modal datasets based on the generated plurality of feature vectors using the trained transformer model;
modifying, by the processor, at least one domain policy associated with the enterprise based on the generated at least one decision-making strategy and real-time feedback using an Artificial Intelligence (AI) model;
generating, by the processor, a plurality of recommendations for performing at least one action corresponding to the plurality of multi-modal datasets based on the modified at least one domain policy, and historical data; and
outputting, by the processor, the generated plurality of recommendations for performing the at least one action on a user interface of a user device.

12. The method of claim 11, wherein encoding the received plurality of multi-modal datasets into the plurality of latent vectors using the Vector Quantized Variational Autoencoders (VQVAE) model comprises:
training, by the processor, the VQVAE model with pre-processed plurality of multi-modal datasets using a reconstruction loss function and a commitment loss function;
identifying, by the processor, a plurality of hierarchical features within the plurality of multi-modal datasets by transforming the plurality of multi-modal datasets into a continuous latent space using multiple convolutional layers of the trained VQVAE model;
quantizing, by the processor, the identified plurality of hierarchical features to a nearest codebook vectors using codebook parameters, wherein the codebook parameters comprise a number of embeddings (K) and a dimensionality of each embedding vector (D); and
generating, by the processor, the plurality of latent vectors by reconstructing the plurality of multi-modal datasets from the quantized nearest codebook vectors using transposed convolutional layers of the trained VQVAE model.

13. The method of claim 11, wherein training the transformer model based on the encoded plurality of latent vectors comprises:
training, by the processor, the transformer model with the encoded plurality of latent vectors to predict correlation feature vectors from the encoded plurality of latent vectors;
determining, by the processor, ground truth correlation feature vectors obtained from statistical measures, attention weights of the transformer model, and target attention weights based on domain-specific insights and predefined attention patterns;
computing, by the processor, a plurality of loss functions based on determined at least one of the predicted correlation feature vectors, the ground truth correlation feature vectors obtained from the statistical measures, the attention weights from the trained transformer model, and the target attention weights based on the domain-specific insights and the predefined attention patterns, wherein the plurality of loss functions comprise at least one of a Correlation Alignment Loss function, an Attention Alignment Loss function, and a Regularization Loss function;
determining, by the processor, a set of model parameters for meeting a minimum loss function level based on the computed plurality of loss functions; and
tuning, by the processor, the trained transformer model based on the determined set of model parameters to predict the plurality of correlations between the plurality of multi-modal datasets.

14. The method of claim 11, wherein generating the plurality of feature vectors using the trained transformer model comprises:
determining, by the processor, a plurality of dependencies and relationships between each of the plurality of multi-modal datasets using the trained transformer model; and
generating, by the processor, the plurality of feature vectors using the trained transformer model, and the determined plurality of dependencies and the correlations.

15. The method of claim 11, wherein generating the at least one decision-making strategy for each of the plurality of multi-modal datasets based on the generated plurality of feature vectors using the transformer model comprises:
computing, by the processor, an impact matrix for the plurality of multi-modal datasets based on the generated plurality of feature vectors using the trained transformer model;
determining, by the processor, at least one equilibrium point for a plurality of decision-making strategies based on the computed impact matrix;
identifying, by the processor, an appropriate decision-making strategy among the plurality of decision-making strategies based on the determined at least one equilibrium point for each of the plurality of multi-modal datasets, wherein the appropriate decision-making strategy corresponds to the determined at least one equilibrium point; and
generating, by the processor, the at least one decision-making strategy for each of the plurality of multi-modal datasets based on the identified appropriate decision-making strategy.

16. The method of claim 11, wherein modifying the at least one domain policy associated with the enterprise based on the generated at least one decision-making strategy and real-time feedback using the AI model comprises:
determining, by the processor, a state space layer of the artificial intelligence model based on the generated at least one decision-making strategy, wherein the state space layer comprises a plurality of metrics comprising a budget allocation, a system performance, security incidents and project progress;
determining, by the processor, an action space layer of the artificial intelligence model based on the generated at least one decision-making strategy, wherein the action space layer comprises predicted actions;
computing, by the processor, a reward function indicating feedback on outcomes of the predicted actions based on the determined action space layer and the state space layer;
generating, by the processor, a simulation environment of the enterprise emulating a real-world environment of the enterprise using real-world constraints and dynamics;
training, by the processor, a reinforcement learning (RL) agent with the computed reward function, the determined action space layer, and the state space layer in the generated simulation environment;
generating, by the processor, a plurality of training datasets corresponding to the generated at least one decision-making strategy by simulating the trained RL agent in the generated simulation environment,
predicting, by the processor, a plurality of actions and a corresponding outcome associated with each of the plurality of actions based on the generated plurality of training datasets;
determining, by the processor, the at least one domain policy associated with the enterprise required to be modified based on the predicted plurality of actions and the corresponding outcome associated with each of the plurality of actions; and
modifying, by the processor, the at least one domain policy associated with the enterprise based on the determination.

17. The method of claim 11, further comprising:
capturing, by the processor, real-time feedback and performance metrics associated with real-world enterprise environment; and
periodically updating, by the processor, the at least one domain policy based on the captured real-time feedback and the performance metrics.

18. The method of claim 11, further comprising:
obtaining, by the processor, historical data corresponding to the enterprise from the plurality of data sources;
generating, by the processor, a time-series data for the obtained historical data by preprocessing the obtained historical data; and
predicting, by the processor, temporal patterns, a plurality of anomalies and forecasted values for the obtained historical data by training a Long Short-Term Memory (LSTM) model with the generated time-series data.

19. The method of claim 11, wherein generating the plurality of recommendations for performing the at least one action corresponding to the plurality of multi-modal datasets based on the modified at least one domain policy, and the historical data, comprises:
computing, by the processor, a first confidence score for the modified at least one domain policy based on a performance of the trained RL agent;
computing, by the processor, a second confidence score for the predicted temporal patterns, the plurality of anomalies and the forecasted values based on prediction accuracy, error margins, and consistency of historical data trends of the trained LSTM model;
computing, by the processor, a first weight for the modified at least one domain policy based on the first confidence score and the second confidence score;
computing, by the processor, a second weight for the predicted temporal patterns, the plurality of anomalies and the forecasted values based on the second confidence score and the first confidence score;
computing, by the processor, a final output based on the first confidence score, the second confidence score, the first weight, and the second weight; and
generating, by the processor, the plurality of recommendations for performing the at least one action based on the final output.

20. A non-transitory computer readable medium comprising a processor-executable instructions that cause a processor to:
receive a plurality of multi-modal datasets from a plurality of data sources, wherein the plurality of multi-modal datasets comprises datasets from a plurality of domains corresponding to a plurality of functions within an enterprise;
encode the received plurality of multi-modal datasets into a plurality of latent vectors using a Vector Quantized Variational Autoencoders (VQVAE) model, wherein the plurality of latent vectors represents essential features of the received plurality of multi-modal datasets;
train a transformer model based on the encoded plurality of latent vectors;
generate a plurality of feature vectors using the trained transformer model, wherein the plurality of feature vectors represents a plurality of correlations between the multi-modal datasets;
generate at least one decision-making strategy for each of the plurality of multi-modal datasets based on the generated plurality of feature vectors using the trained transformer model;
modify at least one domain policy associated with the enterprise based on the generated at least one decision-making strategy and real-time feedback using an Artificial Intelligence (AI) model;
generate a plurality of recommendations for performing at least one action corresponding to the plurality of multi-modal datasets based on the modified at least one domain policy, and historical data; and
output the generated plurality of recommendations for performing the at least one action on a user interface of a user device.
